(19) United States
(12) Patent Application Publication
(10) Pub. No.: US 2016/0171577 A1
(43) Pub. Date: Jun. 16, 2016

(54) SYSTEM AND METHOD FOR PROVIDING IN-PERSON RETAILER ASSISTANCE TO CUSTOMERS IN A RETAIL ENVIRONMENT

(71) Applicant: Meijer, Inc., Grand Rapids, MI (US)

(72) Inventors: Elmer L. Robinson, JR., Marne, MI (US); David Scott Pallas, Hudsonville, MI (US); Michael Mullican, Grand Rapids, MI (US); K. Michael Ross, Grand Rapids, MI (US); James Kevin Symancyk, Ada, MI (US); Brian Pugh, Grand Rapids, MI (US)

(21) Appl. No.: 14/965,717

(22) Filed: Dec. 10, 2015

Related U.S. Application Data
(60) Provisional application No. 62/090,183, filed on Dec. 10, 2014.

(51) Int. Cl. G06Q 30/06; G01S 1/68; H04W 4/04; G06Q 10/06; G06F 17/30

(52) U.S. Cl. CPC G06Q 30/0613; G06Q 10/06311; G06F 17/30386; H04W 4/04; G01S 1/68

(57) ABSTRACT

A system and method of providing in-person retailer assistance to customers of a retail enterprise includes associating locations within a brick-and-mortar outlet of the retail enterprise with different identification codes, associating customer codes with various customers of the retail enterprise, and associating employee codes with various employees of the brick-and-mortar outlet, and in response to a wirelessly received help request, customer code and one or more identification codes, one of the customer codes is identified that matches the wirelessly received customer code, each of the locations is identified that matches one of the one or more wirelessly received identification codes, a customer location within the brick-and-mortar outlet is determined based on the identified locations, and the help request, the identity of the customer and the customer location within the brick-and-mortar outlet are wirelessly transmitted to one or more employee mobile communication devices.

### CROSS-REFERENCE TO RELATED APPLICATIONS

This patent application claims the benefit of, and priority to, U.S. Provisional Patent Application Ser. No. 62/090,183, filed Dec. 10, 2014, the disclosure of which is expressly incorporated herein by reference.

### FIELD OF THE INVENTION

The present invention relates generally to systems and methods for providing retailer assistance to customers in retail environment, and more specifically to systems and methods for locating, by retailer employees, of customers within a brick-and-mortar store of the retail enterprise that have requested retailer assistance.

### BACKGROUND

Retailers of goods and services typically offer such goods and services for purchase via one or more conventional brick-and-mortar retail stores. In some such stores, items for purchase are typically stocked in shelving and/or display units arranged in aisles and/or merchandise areas, and visiting customers typically select desired items for purchase from such shelving and/or display units. From time to time, customers may desire assistance from store employees to, for example, answer questions, locate items within a store, obtain out-of-stock items from a store room, assist in carrying or otherwise transporting one or more items, assist in shopping activities, or the like. It may therefore be desirable for retailers to provide for an arrangement by which customers can selectively request and obtain assistance from store employees when shopping at the retailer's brick-and-mortar stores.

### SUMMARY

The present invention may comprise one or more of the features recited in the attached claims, and/or one or more of the following features and combinations thereof. In one aspect, a method of providing in-person retailer assistance to customers of a retail enterprise may comprise associating, with a processor in a first database, each of a plurality of locations within a brick-and-mortar outlet of the retail enterprise with a different identification code, associating, with the processor in the first or a second database, each of a plurality of customer codes with a different one of a plurality of customers of the retail enterprise, and associating each of a plurality of employee codes identifying a different one of a plurality of employees of the brick-and-mortar outlet with a mobile communication device associated with the different one of the plurality of employees, and in response to a wirelessly received help request, customer code and one or more identification codes, identifying with the processor the one of the plurality of customer codes in the first or second database that matches the wirelessly received customer code, identifying with the processor each of the plurality of locations associated in the first database with an identification code that matches one of the one or more wirelessly received identification codes, determining with the processor a customer location within the brick-and-mortar outlet based on the identified one or more locations, and wirelessly transmitting to one or more of the plurality of employee mobile communication devices, under control of the processor, the help request and an identity of the customer associated in the first or second database with the matching one of the plurality of customer codes and the customer location within the brick-and-mortar outlet.

In another aspect, a system for providing in-person retailer assistance to customers of a retail enterprise may comprise a plurality of wireless signal broadcasting devices located in a brick-and-mortar outlet of the retail enterprise, at least one database having stored therein a plurality of device codes each identifying a different one of the plurality of wireless signal broadcasting devices and each associated in the at least one database with a location within the brick-and-mortar outlet of the different one of the plurality of wireless signal broadcasting devices, a plurality of customer codes each identifying a different one of a plurality of customers of the retail enterprise, and a plurality of employee codes each identifying a different one of a plurality of employees of the brick-and-mortar outlet of the retail enterprise and each associated in the at least one database with a different employee mobile communication device, a processor, and memory having instructions stored therein which, when executed by the processor, cause the processor, in response to a wirelessly received help request, customer code and one or more device codes, to identify the one of the plurality of customer codes in the at least one database that matches the wirelessly received customer code, to identify each of the plurality of device codes in the at least one database that match one of the one or more wirelessly received device codes, to identify each device location associated in the at least one database with the matching one or more device codes, to determine a customer location within the brick-and-mortar outlet based on the one or more identified device locations, and to wirelessly transmit to one or more of the plurality of employee mobile communication devices the help request, an identity of the customer associated in the at least one database with the matching one of the plurality of customer codes and the customer location within the brick-and-mortar outlet.

In yet another aspect, a system for providing in-person retailer assistance to customers of a retail enterprise may comprise a plurality of wireless signal broadcasting devices located in a brick-and-mortar outlet of the retail enterprise, at least one database having stored therein a plurality of device codes each identifying a different one of the plurality of wireless signal broadcasting devices and each associated in the at least one database with a location within the brick-and-mortar outlet of the different one of the plurality of wireless signal broadcasting devices, a plurality of customer codes each identifying a different one of a plurality of customers of the retail enterprise, and a plurality of employee codes each identifying a different one of a plurality of employees of the brick-and-mortar outlet of the retail enterprise and each associated in the at least one database with a different employee mobile communication device, and a server coupled to each of the plurality of wireless signal broadcasting devices and including at least one module to, in response to a wirelessly received help request, customer code and one or more device codes, identify the one of the plurality of customer codes in the at least one database that matches the wirelessly received customer code, identify each of the plurality of device codes in the at least one database that match one of the one or more wirelessly received device codes, identify each device location associated in the at least one database with the matching one or more device codes, determine a customer location within the brick-and-mortar outlet based on the one or more identified device locations, and wirelessly transmit to one or more of the plurality of employee mobile communication devices the help request, an identity of the customer associated in the at least one database with the matching one of the plurality of customer codes and the customer location within the brick-and-mortar outlet.

In still another aspect, a non-transitory machine-readable medium may comprise a plurality of instructions which, when executed by at least one processor, result in the at least one processor associating in a first database each of a plurality of locations within a brick-and-mortar outlet of the retail enterprise with a different identification code, associating in the first or a second database each of a plurality of customer codes with a different one of a plurality of customers of the retail enterprise, and associating each of a plurality of employee codes identifying a different one of a plurality of employees of the brick-and-mortar outlet with a mobile communication device associated with the different one of the plurality of employees, and in response to a wirelessly received help request, customer code and one or more identification codes, identifying the one of the plurality of customer codes in the first or second database that matches the wirelessly received customer code, identifying each of the plurality of locations associated in the first database with an identification code that matches one of the one or more wirelessly received identification codes, determining a customer location within the brick-and-mortar outlet based on the identified one or more locations, and wirelessly transmitting to one or more of the plurality of employee mobile communication devices the help request, an identity of the customer associated in the first or second database with the matching one of the plurality of customer codes and the customer location within the brick-and-mortar outlet.

In a further aspect, a method of providing in-person retailer assistance to customers of a retail enterprise may comprise with communication circuitry of a customer mobile communication device located within a broadcast range of one or more wireless signal broadcasting devices located in and throughout at least a portion of a brick-and-mortar outlet of the retail enterprise, detecting one or more corresponding wireless identification signals broadcast by the one or more in-range wireless signal broadcasting devices, the one or more wireless identification signals each carrying an identification code that uniquely identifies the wireless signal broadcasting device and distinguishes the wireless signal broadcasting device from one or more other wireless signal broadcasting devices in the brick-and-mortar outlet, under control of a first processor carried by the customer mobile communication device, and in response to manual selection of a help button on the customer mobile communication device, transmitting to a server of the retail enterprise a first wireless signal carrying a help request and the one or more identification codes carried by the detected one or more wireless identification signals, as part of the first wireless signal or separately from the first wireless signal, wireless transmitting, under control of the first processor, a customer code stored in a memory of the customer mobile communication device, with at least a second processor associated with the server, comparing the one or more identification codes carried by the first wireless signal with a plurality of identification codes stored in at least one database, each one of the plurality of stored identification codes identifying a different wireless signal broadcasting device located in the brick-and-mortar outlet, to identify a location within the brick-and-mortar outlet associated in the at least one database with each corresponding one of the plurality of stored identification codes that matches one of the one or more identification codes carried by the first wireless signal, with the at least a second processor associated with the server, determining a location of the customer mobile communication device within the brick-and-mortar outlet based on the identified one or more locations within the brick-and-mortar outlet, with the at least a second processor, comparing the customer code wirelessly transmitted by the customer mobile communication device with a plurality of customer codes stored in at least one database, each of the plurality of stored customer codes associated in the at least one database with a different one of a plurality of customers of the retail enterprise, to identify the one of the plurality of stored customer codes that matches the customer code wirelessly transmitted by the customer mobile communication device, and under control of the at least a second processor, transmitting to one or more employee mobile communication devices a second wireless signal carrying the help request, an identity of the customer associated in the at least one database with the matching one of the plurality of customer codes and the customer location within the brick-and-mortar outlet, each of the one or more employee mobile communication devices associated in the at least one database with a corresponding employee of the retail enterprise at the brick-and-mortar outlet.

In still a further aspect, a system for providing in-person retailer assistance to customers of a retail enterprise may comprise a plurality of wireless signal broadcasting devices located in and throughout at least a portion of one of one or more brick-and-mortar outlets of the retail enterprise, each of the plurality of wireless signal broadcasting devices to broadcast wireless identification signals each carrying an identification code that uniquely identifies the corresponding wireless signal broadcasting device and distinguishes the corresponding wireless signal broadcasting device from others of the plurality of wireless signal broadcasting devices, at least one database having stored therein a plurality of device codes each identifying a different one of the plurality of wireless signal broadcasting devices and each associated in the at least one database with a location within the brick-and-mortar outlet of the different one of the plurality of wireless signal broadcasting devices, a plurality of customer codes each identifying a different one of a plurality of customers of the retail enterprise, and a plurality of employee codes each identifying a different one of a plurality of employees of the brick-and-mortar outlet of the retail enterprise and each associated in the at least one database with a different employee mobile communication device, a customer mobile communication device located within a broadcast range of one or more of the plurality of wireless signal broadcasting devices, the mobile communication device including first communication circuitry to detect at least one of the wireless identification signals broadcast by each of the one or more of the plurality of wireless signal broadcasting devices, the customer mobile communication device including a first processor and a first memory having instructions stored therein which, when executed by the first processor, cause the first processor to automatically control the first communication circuitry to wirelessly transmit a first wireless signal in response to detection of wireless identification signals broadcast by one or more of the plurality of wireless signal broadcasting devices, the first wireless signal carrying the identification codes carried by detected ones of the one or more wireless identification signals, and a server associated with the retail enterprise and including at least a second communication circuitry to receive the first wireless signal transmitted by the first communication circuitry of the customer mobile communication device, and at least a second processor and a second memory having instructions stored therein which, when executed by the at least a second processor, cause the at least a second processor to compare the one or more identification codes carried by the first wireless signal with a plurality of identification codes stored in the at least one database to identify a location within the brick-and-mortar outlet associated in the at least one database with each corresponding one of the plurality of stored identification codes that matches one of the one or more identification codes carried by the first wireless signal, to determine a location of the customer mobile communication device within the brick-and-mortar outlet based on the identified one or more locations within the brick-and-mortar outlet, comparing the customer code wirelessly transmitted by the customer mobile communication device with a plurality of customer codes stored in at least one database, each of the plurality of stored customer codes associated in the at least one database with a different one of a plurality of customers of the retail enterprise, to identify the one of the plurality of stored customer codes that matches the customer code wirelessly transmitted by the customer mobile communication device, and to transmit to one or more of the employee mobile communication devices a second wireless signal carrying the help request, an identity of the customer associated in the at least one database with the matching one of the plurality of customer codes and the customer location within the brick-and-mortar outlet.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system for providing in-person retailer assistance to customers in a retail environment.

FIG. 2 is a simplified block diagram of an embodiment of one of the customer mobile communication devices illustrated in FIG. 1.

FIG. 3 is a simplified block diagram of an embodiment of one of the enterprise mobile communication devices illustrated in FIG. 1.

FIG. 4 is a simplified block diagram of an embodiment of an environment of the main server of FIG. 1.

FIG. 5 is a simplified diagram of a communications framework for detecting by a customer mobile communication device of wireless signals produced by wireless signal broadcasting devices located in a brick-and-mortar stores of a retail enterprise, and for conducting wireless communications relating thereto between the customer mobile communication device and the main server of the retail enterprise and also between the main server and an enterprise mobile communication device.

FIG. 6 is a simplified flow diagram of an embodiment of a process for providing in-person retailer assistance to customers in a retail environment.

FIG. 7 is a simplified diagram illustrating a number of examples of detection by the main server, according to the process illustrated in FIG. 6, of the location of the customer within the brick-and-mortar outlet.

FIG. 8 is a simplified flow diagram of an embodiment of a help request process executed in some embodiments of the process illustrated in FIG. 6.

FIG. 9 is a simplified flow diagram of an embodiment of an employee help process executed in some embodiments of the process illustrated in FIG. 6.

FIG. 10 is a simplified flow diagram of an embodiment of a crowd source help process executed in some embodiments of the process illustrated in FIG. 6.

FIG. 11A is a simplified flow diagram of an embodiment of an opt-in process executed in some embodiments of the process illustrated in FIG. 6.

FIG. 11B is a simplified flow diagram of an embodiment of a store exit process executed in some embodiments of the process illustrated in FIG. 6.

FIG. 12 is a simplified flow diagram of an embodiment of a requesting customer exit process executed in some embodiments of the process illustrated in FIG. 6.

FIG. 13 is a simplified flow diagram of an embodiment of a requesting customer tracking process executed in some embodiments of the process illustrated in FIG. 6.

FIG. 14 is a simplified flow diagram of an embodiment of a text communication process executed in some embodiments of the process illustrated in FIG. 6.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

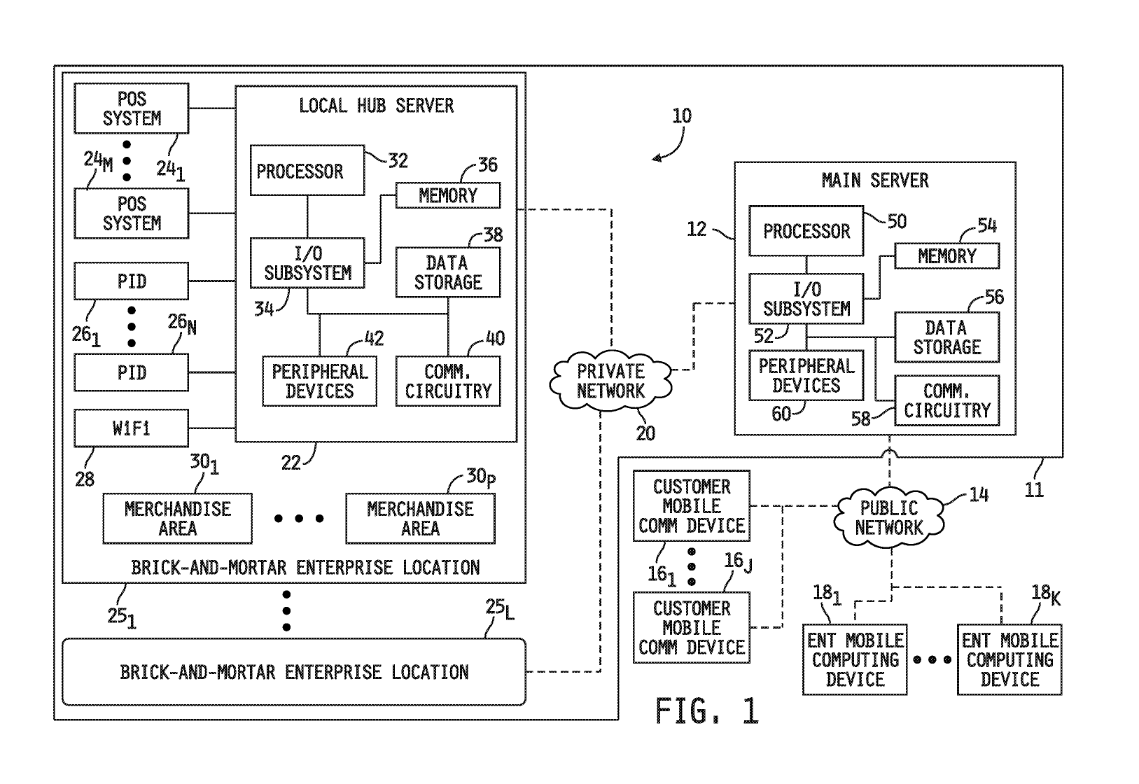

Referring now to FIG. 1, a system 10 is shown system for providing in-person retailer assistance to customers in a retail environment. The system 10 includes a retail enterprise 11 having a main server 12 configured to communicate with customers of the retail enterprise via a public network 14, e.g., the Internet, and customers may access the public network 14 using any conventional public network accessible electronic device and/or system. In the illustrated embodiment, for example a number, J, of mobile communication devices 16₁-16_{J} are shown. Likewise, one or more employees of the retail enterprise 11 may communicate with the main server 12 via the public network 14 using any conventional public network electronic device or system, and in the illustrated embodiment a number, K, of user enterprise mobile computing or communication devices 18₁-18_{K} are shown. Each device 16₁-16_{J} and 18₁-18_{K} is configured to communicatively connect to the public network 14, and J and K may each be any positive integer. The retail enterprise 11 may include any number of brick-and-mortar retail outlets or locations 25₁-25_{L} each having one or more point-of-sale systems 24₁-24_{M}, 24₁-24_{N} operating therein and each including any number, P, of merchandise areas 30₁-30_{P}, e.g., areas where merchandise may be displayed for sale. The main server 12 is configured to communicate with each such point-of-sale (POS) system 24₁-24_{M}, 24₁-24_{N}, each of which operate in a conventional manner to process items to be purchased by shoppers during purchase transactions.

Each of the brick-and-mortar stores 25₁-25_{L} may further include at least one conventional WiFi Access Point 28 which may be coupled to the corresponding local hub server 22, or directly to the main server 12 in any one or more of the brick-and-mortar stores 25₁-25_{L} not having an associated local hub server 22. Each such WiFi Access Point 28 is illustratively controlled by the main server 12 (or corresponding local hub server 22) in a conventional manner to establish at least one corresponding Internet hotspot within the brick-and-mortar store 25 via which customers (and employees) can access the public network 14, e.g., to access the Internet, using any conventional public network accessible electronic device and/or system, e.g., such as with any of the plurality of mobile communication devices 16₁-16_{K}.

In some embodiments, the main server 12 illustratively hosts an enterprise member or membership services (EMS) program which may include or otherwise have access to a virtual coupon bank and/or a customer purchase history database containing purchase histories of one or more customers of the retail enterprise 11. As used herein, the term “enterprise member services program,” “enterprise membership services program” or EMS and “shopper membership service” are interchangeable and refer to a shopper or customer service which may offer to customer members one or more services such as making available to customers one or more virtual discount coupons that may be redeemable by the retail enterprise against the purchase of from the retail enterprise of various goods and/or services and/or tracking and maintaining customer purchase histories in a customer purchase history database accessible by the main server 12. In this regard, the terms “customer membership account” and “EMS account” are likewise interchangeable and refer to a mechanism by which the retail enterprise 11 may make available to customers one or more virtual discount coupons and/or by which a customer's purchase history and information about the customer can be maintained by the main server 12 in a database separately from purchase histories of and information about other customers. Further in this regard, the term “EMS identification code” or EMSID illustratively refers to at least one collection of letters, symbols and/or numbers that is different for, and therefore unique to, each customer member of the enterprise membership services program, and which is used to uniquely identify a customer's EMS account within the enterprise membership services program. In one embodiment, for example, the EMSID for each customer may include a unique, several-digit access code and a separate and unique, several-digit password, although in other embodiments the EMSID may include more, fewer and/or different codes and/or passwords.

As will be discussed in further detail below, the main server 12 illustratively includes an EMS module that manages and controls a customer-member interface, e.g., a web-based interface, to the EMS program via which customers can access and manage their individual EMS accounts. Illustratively, each customer may access their individual (and private from other customer-members) EMS account, i.e., their individual EMS page(s) within the web-based EMS interface, which may be referred to hereinafter as an “EMS website,” by entering that customer's EMSID into a graphic user interface element of the web-based EMS interface. Therein, the customer may access, establish, modify and otherwise manage the customer's EMS account information including, for example, but not limited to, name, address, email address, mobile telephone number, photograph of the customer or the like.

In the embodiment illustrated in FIG. 1, the main server 12 is illustratively coupled via a private network 20 to a plurality of local hub servers 22, each associated with a different one of a plurality of brick-and-mortar enterprise locations 25₁-25_{L}, wherein L may be any positive integer. Each local hub server 22 is coupled to one or more conventional point-of-sale systems, e.g., 24₁-24_{M}. Each of the point-of-sale systems 24₁-24_{M} is configured to process items selected by customers for purchase and to process payment for such items. Some retail enterprises may include a single brick and mortar outlet, and other larger enterprises may include two or more physically remote brick and mortar outlets. In the latter case, the retail enterprise may include, for example, a main physical location with two or more remote physical locations, and for purposes of this document the two or remote physical locations in such an arrangement are referred to as “hub” locations. In this disclosure, the system 10 will be illustrated and described in the context of such a larger retail enterprise having a main physical location and two or more physical hub locations. In this regard, the main server 12 in the system 10 shown in FIG. 1 will typically be located at a main business location of the retail enterprise, and will be coupled via the network 20 to two or more local hub servers 22, each of which will typically be located at a different one of the two or more hub locations.

Each hub location may include any number of point-of-sale systems coupled to a corresponding local hub server, and in the embodiment illustrated in FIG. 1, for example, the local hub server 22 is communicatively coupled to “M” such point-of-sale systems 24₁-24_{M}, where M may be any positive integer. Communicative coupling between the local hub server 22 and the one or more point-of-sale systems 24₁-24_{M} may be accomplished using any known communication coupling, and communications over any such hardwire and/or wireless coupling may be accomplished using any known communication protocol.

In some alternative embodiments of such a large retail enterprise, one or more of the local hub servers 22 may be omitted, and the main server 12 may be coupled directly, via the network 20, to one or more point-of-sale systems 24₁-24_{M} or the main server 12 may be omitted and at least one of the local hub servers 22 may be configured to act as a so-called master server with the remaining local hub servers 22 configured to act as so-called slave servers. In other alternative embodiments in which the retail enterprise 11 includes only a single brick and mortar outlet, the local hub servers 22 may be or include the main server 12 or vice versa. For purposes of the following description, any process disclosed as being controlled by the main server 12 may, in some embodiments, instead be controlled, in whole or in part, by one or more local hub servers 22 and vice versa, and/or may be controlled, in whole or in part, by one of the point-of-sale systems 24₁-24_{M} and vice versa.

The local hub server 22 may be embodied as any type of server (e.g., a web server) or similar computing device capable of performing the functions described herein. In the illustrative embodiment of FIG. 1, the local hub server 22 includes a processor 32, an I/O subsystem 34, a memory 36, a data storage 38, a communication circuitry 40, and one or more peripheral devices 42. It should be appreciated that the local hub server 22 may include other components, sub-components, and devices commonly found in a server and/or computing device, which are not illustrated in FIG. 1 for clarity of the description.

The processor 32 of the local hub server 22 may be embodied as any type of processor capable of executing software/firmware, such as a microprocessor, digital signal processor, microcontroller, or the like. The processor 32 may be a single processor or include multiple processors. The I/O subsystem 34 of the local hub server 22 may be embodied as circuitry and/or components to facilitate input/output operations with the processor 32 and/or other components of the local hub server 22. The processor 32 is communicatively coupled to the I/O subsystem 34.

The memory 36 of the local hub server 22 may be embodied as or otherwise include one or more conventional volatile and/or non-volatile memory devices. The memory 36 is communicatively coupled to the I/O subsystem 34 via a number of signal paths. Although only a single memory device 36 is illustrated in FIG. 1, the local hub server 22 may include additional memory devices in other embodiments. Various data and software may be stored in the memory 36. The data storage 38 is also communicatively coupled to the I/O subsystem 34 via a number of signal paths, and may be embodied as any type of device or devices configured for the short-term or long-term storage of data such as, for example, memory devices and circuits, memory cards, hard disk drives, solid-state drives, or other data storage devices.

The communication circuitry 40 of the local hub server 22 may include any number of devices and circuitry for enabling communications between the local hub sever 22 and the main server 12 and between the local hub server 22 and the one or more point-of-sale systems 24₁-24_{M}. In the illustrated embodiment, for example, communication between the local hub server 22 and the main server 12 takes place wirelessly via the network 20, wherein the network 20 may represent, for example, a private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the local hub server 22 and the main server 12 may be a non-private network and/or may be, in whole or in part, a wired connection. Generally, the communication circuitry 40 may be configured to use any one or more, or combination, of conventional secure and/or unsecure communication protocols to communicate with the main server 12. As such, the network 20 may include any number of additional devices, such as additional computers, routers, and switches, to facilitate communications between the local hub server 22 and the main server 12. Communication between the local hub server 22 and the one or more point-of-sale systems 24₁-24_{M} may take place via one or more such wireless communication interfaces and/or via one or more conventional wired interfaces.

In some embodiments, the local hub server 22 may also include one or more peripheral devices 42. Such peripheral devices 42 may include any number of additional input/output devices, interface devices, and/or other peripheral devices. For example, the peripheral devices 42 may include a display, a keyboard, a mouse, audio processing circuitry, and/or other input/output devices.

Other local hub servers, e.g., serving other brick-and-mortar locations 25₁-25_{L}, may be substantially similar to the local hub server 22 and include similar components. As such, the description provided above of the components of the local hub server 22 may be equally applicable to such similar components of other local hub servers and are not repeated herein so as not to obscure the present disclosure. Of course, it should be appreciated that in some embodiments one or more of the local hub servers 22 and may be dissimilar to others of the local hub servers 22.

An embodiment of the main server 12 is also illustrated in FIG. 1, and generally includes the same components as the local hub server 22. For example, a processor 50 is coupled to an I/O subsystem 52, and the I/O subsystem 52 is coupled to a memory 54, a data storage unit 56, communication circuitry 58 and one or more peripheral devices 60. In some embodiments, each of the foregoing components may be identical to corresponding components of the local hub server 22 described above, and a detailed explanation of such components will not be repeated here for brevity. In other embodiments, the main server 12 may be configured differently than the local hub server 22 described above. In any case, the communication circuitry 40 of each of the local hub servers 22 facilitates communication with the communication circuitry 58 of the main server 12 and vice versa so that information can be shared between the main server 12 and each of the one or more local hub servers 22 via the network 20. Although only one such main server 12 is shown in FIG. 1, it should be appreciated that, in other embodiments, the system 10 may include any number of shopper main servers, and in still other embodiments the main server 12 may be communicatively coupled to one or more remote servers of the retail enterprise. Any such one or more remote servers may include any structure or feature illustrated and described herein with respect to the main server 12, and may be configured to execute any one or more functions described with respect to the main server 12 either alternatively to the main server 12 or in addition to the main server 12. In any case, the main server 12 may be embodied as any type of server (e.g., a web server) or similar computing device capable of performing the functions described herein.

The mobile communication devices 16₁-16_{J} illustrated in FIG. 1 are intended to depict mobile communication devices that are each separately owned and/or operated by a different customer. No limit on the total number of such mobile communication devices 16₁-16_{J} that may be owned and operated by any one customer, or on the total number of such mobile communication devices 16₁-16_{J} that may communicate with the main server 12, is intended or should be inferred. The mobile communication devices 18₁-18_{K} illustrated in FIG. 1 are intended to depict mobile communication devices that are each separately owned, issued to or assigned by the retail enterprise to, a different employee of the retail enterprise 11. No limit on the total number of such mobile communication devices 18₁-18_{K} that may communicate with the main server 12, is intended or should be inferred. The mobile communication devices 16₁-16_{J} and 18₁-18_{K} may be or include any mobile electronic device capable of executing one or more software application programs as described herein and of communicating with the main server 12 via the public network 14. Examples of the mobile communication devices 16₁-16_{J} and 18₁-18_{K} include, but should not be limited to, mobile telephones, smart phones, tablet computers, personal data assistants (PDAs), and the like.

Also depicted in FIG. 1 are a number of conventional position identification devices (PIDs) 26₁-26_{N} each illustratively coupled to the local hub server 22 in a different one of the brick-and-mortar enterprise locations 25₁-25_{L} such that each brick-and-mortar enterprise location includes a plurality of such position identification devices 26₁-26_{N}. In alternate embodiments, one or more or all of the PIDs 26₁-26_{N} may not be coupled to the local hub server 22. In one embodiment, the position identification devices 26₁-26_{N} are provided in the form of conventional electronic wireless signal broadcasting devices 224, e.g., conventional radio frequency broadcasting beacons, for the purpose of broadcasting radio signals carrying information corresponding to the location and/or identity thereof, and will be described in the remainder of this document as such. It will be understood, however, that this disclosure contemplates other embodiments in which one or more of the position identification devices 26₁-26_{N} is/are provided in another form. Examples of such other forms will be described at the end of this document.

The wireless signal broadcasting devices 26₁-26_{N} will, for purposes of this disclosure, be described as being implemented in the form of such wireless signal broadcasting devices, although it will be understood that one or more of the wireless signal broadcasting devices 26₁-26_{N} may alternatively take the form of one or more other conventional wireless signal broadcasting devices operable to broadcast wireless signals carrying information corresponding to the location and/or identity of thereof.

Illustratively, the wireless signal broadcasting devices 26₁-26_{N} in each of the plurality of brick-and-mortar enterprise locations 25₁-25_{L} are distributed and located throughout the brick-and-mortar location such that each broadcasts wireless signals from different locations throughout the brick-and-mortar enterprise location 25. In some embodiments, the wireless signal broadcasting devices 26₁-26_{N} are mounted or placed sequentially in rows and columns within and throughout each brick-and-mortar enterprise location 25₁-25_{L}. In any case, each such wireless signal broadcasting device 26₁-26_{N} is configured to periodically broadcast one or more unique wireless identification signals, i.e., one or more identification signals that distinguish the particular wireless signal broadcasting device 26 from other wireless signal broadcasting devices 26.

In some embodiments, the wireless signal broadcasting devices 26₁-26_{N} are each configured to periodically broadcast wireless identification signals in the radio frequency (RF) range, although any of the one or more wireless signal broadcasting devices 26₁-26_{N} may be configured to alternatively broadcast wireless identification signals in one or more other frequency ranges. In any case, the wireless signal broadcasting devices 26₁-26_{N} are further each illustratively configured to broadcast wireless identification signals with a predefined broadcast range and/or orientation (i.e., direction).

Illustratively, the unique wireless identification signals broadcast by each wireless signal broadcasting device 26₁-26_{N} carry decodable information in the form of a unique identification code (UID). Generally, the UID of each wireless signal broadcasting device 26₁-26_{N} uniquely identifies that wireless signal broadcasting device and distinguishes that wireless signal broadcasting device from all other wireless signal broadcasting devices within the retail enterprise 11 or at least those located in any one brick-and-mortar enterprise location 25. Those skilled in the art will recognize additional and/or alternative information that may be included within or appended to the UID, and/or carried by the unique wireless identification signals broadcast by the wireless signal broadcasting devices 26₁-26_{N}, and it will be understood that any such additional and/or alternative information is contemplated by this disclosure.

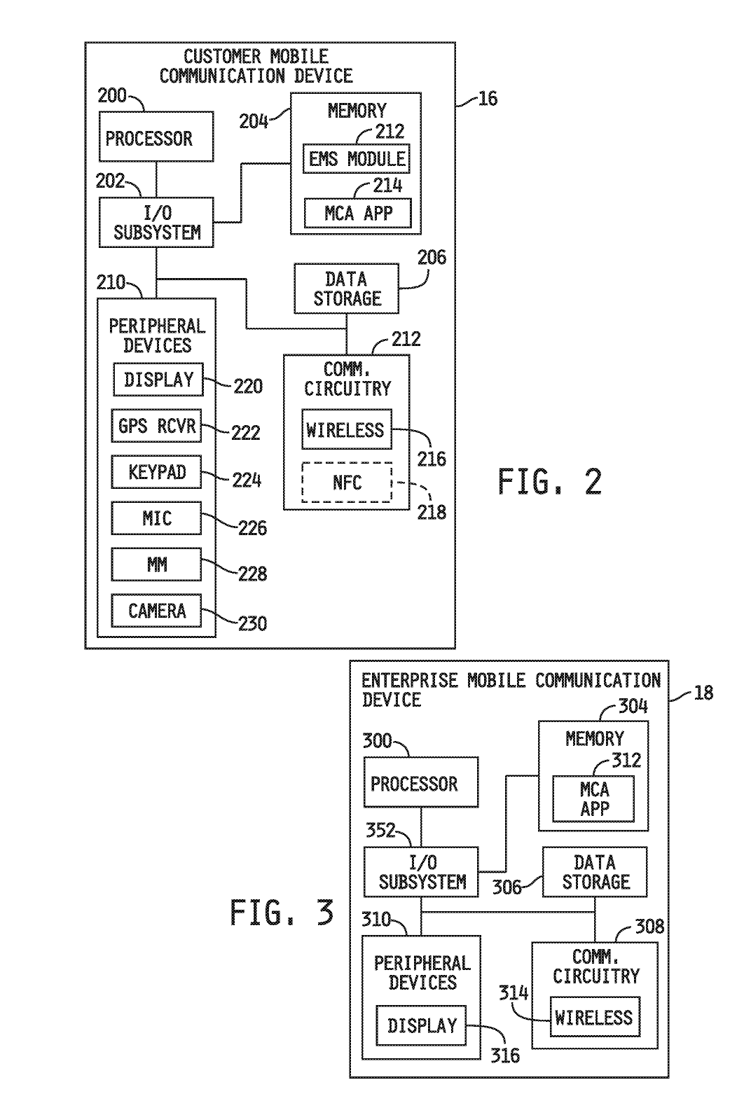

Referring now to FIG. 2, an embodiment of one of the mobile communication devices 16 illustrated in FIG. 1 is shown, which illustratively includes components similar to the main server 12 and also to the one or more local hub servers 22 and the one or more POS systems 241-24M such as a processor 200, an I/O subsystem 202, a memory 204 including an EMS module 212, a data storage device 206, communication circuitry 212 and a number of peripheral devices 210. In some embodiments, each of the foregoing components may be identical to corresponding components of the local hub server 22 described above, and a detailed explanation of such components will not be repeated here for brevity. In other embodiments, any of the one or more mobile communication devices 161-16J may be configured differently than the local hub server 22 described above. It will be appreciated that the mobile communication device 16 may include other components, sub-components, and devices commonly found in a computer and/or computing device.

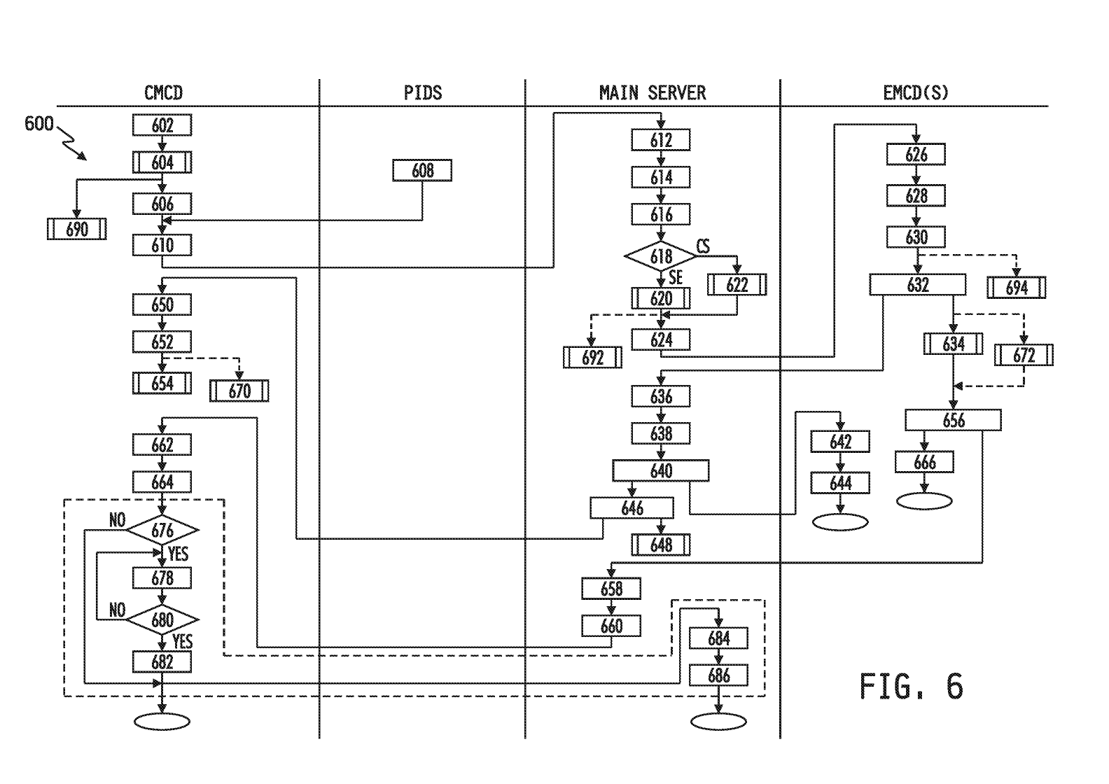

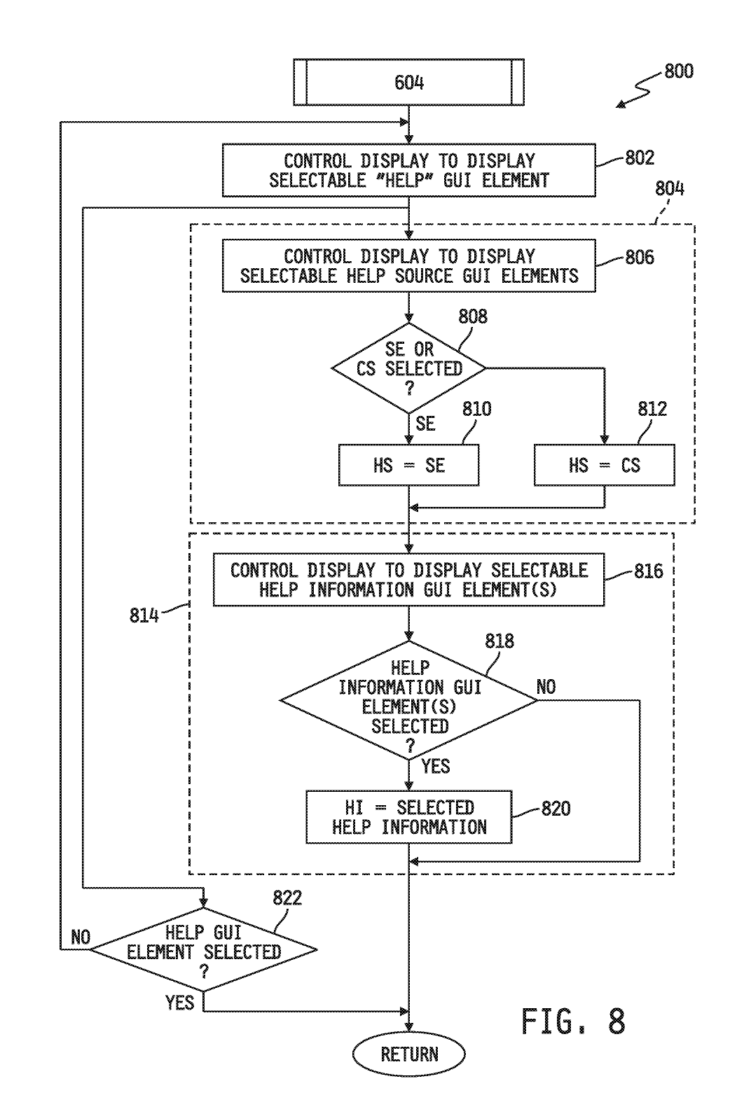

The memory 204 illustratively includes an EMS module 212 in the form of, e.g., instructions executable by the processor 200 to communicate EMS customer-member information to and from the main server 12, and to control one or more local peripheral devices to facilitate communications between customer-members of the enterprise membership service (EMS) program and the main server 12 and to facilitate customer input of customer-identifying information, e.g., an EMS identifying number and/or code (EMSID). The memory 204 further illustratively includes a mobile customer assistance (MCA) application 214 in the form of, e.g., instructions executable by the processor 200 to facilitate requesting in-person assistance from one or more employees of the retail enterprise 11 while shopping at any of the brick-and-mortar enterprise locations 251-25L. An example embodiment of the MCA application 214 will be described in greater detail hereinafter with respect to FIGS. 6 and 8.

The communication circuitry 212 illustratively includes conventional wireless communication circuitry 216. In some embodiments, the wireless communication circuitry 216 is configured to conduct and facilitate cellular telephone communications with other cellular and land-based communication devices. In some embodiments, the wireless communication circuitry 216 is configured to conduct and facilitate communication with the main server 12 via the network 14. In some embodiments, the wireless communication circuitry 216 is configured to access the network 14 via at least one hotspot established in any of the brick-and-mortar stores 25₁-25_{L} by a corresponding at least one WiFi Access Point 28. In some embodiments, the wireless communication circuitry 216 may further be configured to conduct and facilitate communication with one or more of the position identification devices 26₁-26_{N} in any of the brick-and-mortar stores 25₁-25_{L}. The wireless communication circuitry 216 may illustratively include conventional communication circuitry for conducting and facilitating any such communication, and examples of such conventional communication circuitry include, but are not limited to, one or more conventional radio frequency (RF) transceivers configured to receive and transmit signals at multiple radio frequencies, one or more conventional modem or other communication circuits configured to access and conduct communications via the Internet, and the like. The mobile communication device 16 may illustratively use any suitable communication protocol via the network 14 or other network to communicate with the main server 12, with other cellular and land-based communication devices and/or with one or more of the position identification devices 26₁-26_{N} in any of the brick-and-mortar stores 25₁-25L.

The communication circuitry 212 may, in some embodiments, optionally include conventional near-field communication circuitry 218 as illustrated by dashed-line representation. In such embodiments, the near-field communication circuitry 218 is illustratively configured to communicate with a near-field sensor or interface of another electronic device or system to transfer, upon contact or near-contact therewith, information from the mobile communication device 16 to the other electronic device or system and/or vice versa

In addition to, or alternatively to, the number of peripheral devices 40 of the local hub server 22 described above, the number of peripheral devices 210 of the mobile communication device 16 may include any number of other or additional peripheral or interface devices. Examples of such additional peripheral devices illustrated in FIG. 2 include, but should not be limited to, a conventional visual display unit or screen 220, a conventional global positioning system (GPS) receiver 222, a conventional camera 230, a conventional keypad 224, a conventional microphone 226 and a conventional magnetometer 228. The display 220 is configured, in a conventional manner, to be responsive to instructions produced by the processor 200 to display information thereon. The GPS receiver 222 is configured, in a conventional manner, to receive radio-frequency signals transmitted by earth-orbiting satellites and to produce corresponding signals from which geographical coordinates of the receiver 222 are or can be determined. The camera 230 is configured, in a conventional manner, to capture images and/or video and to display the same on the display 220. The keypad 224 is configured, in a conventional manner, to provide signals corresponding to manual selection and activation thereof to the processor 200, and the microphone 226 is configured, in a conventional manner, to capture sound waves and to provide signals corresponding thereto to the processor 200. The magnetometer 228 is configured, in a conventional manner, to detect local geomagnetic fields, to produce magnetic signature signals based thereon and to provide such signals to the processor 200.

Referring now to FIG. 3, an embodiment of one of the mobile communication devices 18 illustrated in FIG. 1 is shown, which illustratively includes components similar to the main server 12 and also to the one or more local hub servers 22 and the one or more POS systems 24₁-24_{M} such as a processor 300, an I/O subsystem 302, a memory 304, a data storage device 306, communication circuitry 308 and a number of peripheral devices 310. In some embodiments, each of the foregoing components may be identical to corresponding components of the local hub server 22₁ and/or POS system 24 described above, and a detailed explanation of such components will not be repeated here for brevity. In other embodiments, any of the one or more mobile communication devices 18₁-18_{K} may be configured differently than the local hub server 22 described above. It will be appreciated that the mobile communication device 18 may include other components, sub-components, and devices commonly found in a computer and/or computing device.

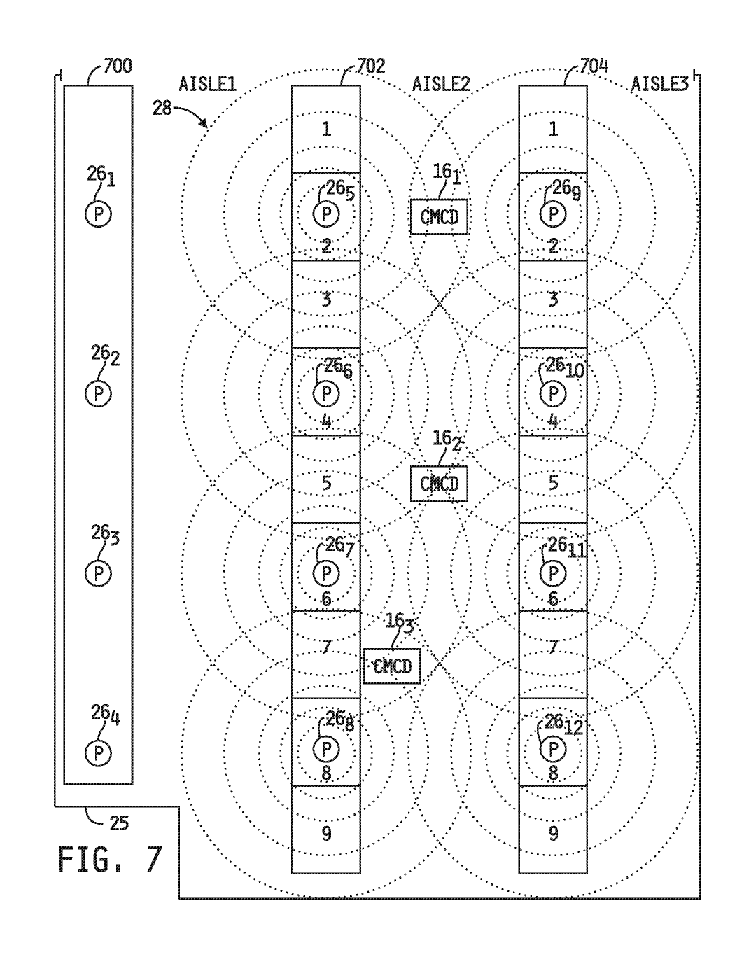

The memory 304 illustratively includes a mobile customer assistance (MCA) application 312 in the form of, e.g., instructions executable by the processor 300 to facilitate providing in-person assistance to customers requesting such in-person assistance while shopping at any of the brick-and-mortar enterprise locations 25₁-25_{L}. An example embodiment of the MCA application 310 will be described in greater detail hereinafter with respect to FIGS. 6 and 7.

The communication circuitry 308 illustratively includes conventional wireless communication circuitry 314. In some embodiments, the wireless communication circuitry 314 is configured to conduct and facilitate cellular telephone communications with other cellular and land-based communication devices. In some embodiments, the wireless communication circuitry 314 is configured to conduct and facilitate communication with the main server 12 via the network 14. In some embodiments, the wireless communication circuitry 314 is configured to access the network 14 via at least one hotspot established in any of the brick-and-mortar stores 25₁-25_{L} by a corresponding at least one WiFi Access Point 28. In some embodiments, the wireless communication circuitry 314 may further be configured to conduct and facilitate communication with one or more of the position identification devices 26₁-26_{N} in any of the brick-and-mortar stores 25₁-25_{L}. The wireless communication circuitry 314 may illustratively include conventional communication circuitry for conducting and facilitating any such communication, and examples of such conventional communication circuitry include, but are not limited to, one or more conventional radio frequency (RF) transceivers configured to receive and transmit signals at multiple radio frequencies, one or more conventional modem or other communication circuits configured to access and conduct communications via the Internet, and the like. The mobile communication device 16 may illustratively use any suitable communication protocol via the network 14 or other network to communicate with the main server 12, with other cellular and land-based communication devices and/or with one or more of the position identification devices 26₁-26_{N} in any of the brick-and-mortar stores 25₁-25_{L}.

In addition to, or alternatively to, the number of peripheral devices 40 of the local hub server 22 described above, the number of peripheral devices 310 of the mobile communication device 18 may include any number of other or additional peripheral or interface devices. One example of such an additional peripheral device illustrated in FIG. 3 includes, but should not be limited to, a conventional visual display unit or screen 316.

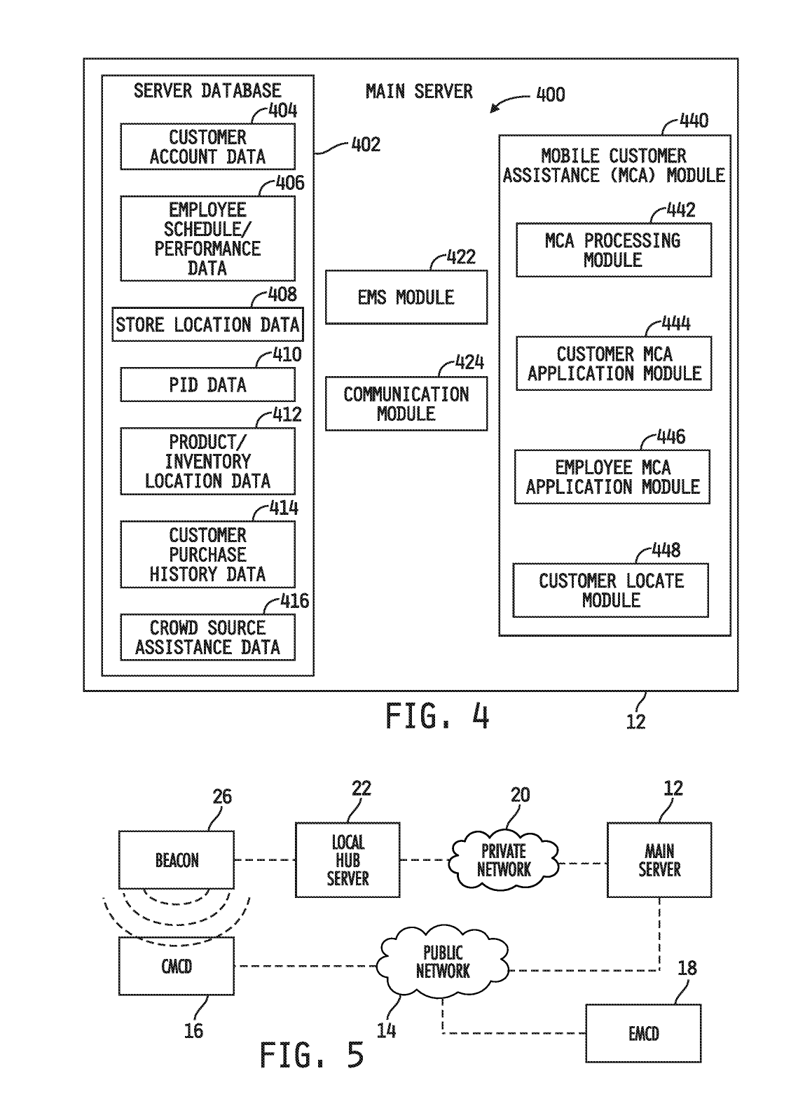

Referring now to FIG. 4, a simplified block diagram is shown of an embodiment of an environment 400 of the main server 12 illustrated in FIG. 1. In the embodiment shown in FIG. 4, the environment 400 includes a server database 402 which illustratively includes customer account data 404, employee schedule/performance data 406, store location data 408, PID data 410, product/inventory location data 412, customer purchase history data 414 and crowd source assistance data 416.

Customers may elect to participate in an enterprise membership services (EMS) program offered, managed and maintained by the retail enterprise 11, by establishing a user account (which may be referred to herein as an “EMS account” or “customer account”) within the server 12, which user account may in some cases be an individual account accessible only by an individual person, e.g., an individual customer, and in other cases may be a group or “household” account accessible by each of a plurality of members of a predefined group of persons, e.g., members of a family or household, one or more employees of a business enterprise, etc. The terms “shopper,” “member,” “customer member,” “customer” and “household,” and variants thereof, are used interchangeably in the following description, and such terms should be understood to refer interchangeably to an individual shopper or a predefined group of individual shoppers (referred to herein as a “household”) who shop at and purchase items from a retail enterprise, and who are members of an enterprise membership service (EMS) of the type described herein and provided and managed by the retail enterprise 11.

Illustratively, a software application program is available for download from the main server 12 via the public network 14 for shoppers electing to access the EMS program via their mobile communication device, e.g., one of the mobile communication devices 16₁-16_{J}. Once downloaded and activated, shoppers can access and manage their EMS account and program features via the software application program executed by their mobile communication device 16₁-16_{J}. Illustratively, the main server 12 additionally hosts and controls an EMS website accessible via the public network 14, and in such embodiments shoppers can access and manage their EMS accounts and program features by accessing their EMS page(s) of the EMS website hosted by the main server 12 via a computing device and/or via their mobile communication device 16₁-16_{J} if the latter is equipped with a web browser.

In the illustrated embodiment, the customer account data 404 of the server database 402 has stored therein information relating to user accounts and profile data for each of the members of the EMS program. As shoppers join the EMS program, the server 12 establishes an EMS account within the customer account data 404 that is unique to the customer, and assigns to the shopper, and/or the shopper selects, a unique, corresponding enterprise membership services identification code, EMSID, as briefly described hereinabove. The EMSID associated with each customer is entered into the server 12 is stored along with the customer's profile data in the customer account data 404, and can be used thereafter to access the customer's EMS account. The customer account data 404 illustratively further includes additional information relating to the various customer-members of the EMS program. Examples of such additional information include, but are not limited to, customer name, customer address, communication information (CI) of a mobile communication device 16 carried by the customer, and the like. In one embodiment, the communication information (CI) may be or include the telephone number of the customer's mobile communication device 16. In other embodiments, the communication information (CI) may be or include a serial number, electronic identification code or other communication identifier associated with the customer's mobile communication device 19. In still other embodiments, the communication information (CI) may be or include, in place of or in addition to a telephone number or communication identifier of the customer's mobile electronic device, one or more other unique mobile electronic device identification codes that identify the specified mobile electronic device 16 for purposes of wireless communication therewith. In any case, all such customer identity information is illustratively associated, i.e., linked or mapped together, in the customer account data 402 such that a search of one customer identity parameter will provide access to the lined customer identity parameters.

In some embodiments, the EMSID may be provided on or as part of one or more of a shopper's ID card, an ID associated with an RFID tag, which RFID tag may be part of the NFC communication circuitry of the mobile communication device 16₁, a shopper's incentive card, or the like. In other embodiments, the EMSID may not be provided in or as part of any tangible form, and may instead be or include one or more easily remembered sequences of numbers, letters, symbols or other characters. In any case, customer members of the EMS program described herein may scan or otherwise communicate or enter via a keypad or touchscreen their EMSID at one of the point-of-sale terminals 24₁-24_{M} and it is through the customer's EMSID that the main server 12 makes virtual discount offers available to the customer and/or associates purchases made by the customer with the customer's purchase history to thereby monitor and track purchases made by the customer from the retail enterprise 11 during purchase transactions. MPERKS®, a virtual customer coupon collection and redemption program offered to customers by Meijer, Inc. of Grand Rapids, Mich., is an example of one such EMS program of the type described herein, although it will be appreciated that any retail enterprise membership service which offers virtual discount coupons and/or other benefits to shopper members, and/or which tracks items purchased by shopper members during item purchase transactions at point-of-sale systems or terminals may be alternatively be used.

The employee schedule/performance data 406 illustratively includes information relating to employee identification information for each employee of the retail enterprise, examples of which may include, but should are not limited to, one or any combination of employee name, one or more digital photographs of the employee, brick-and-mortar location 25 at which the employee is located, work schedule of the employee, the position or function of the employee at the retail enterprise 11, employee work performance evaluations and/or rankings, communication information (CI), of an enterprise mobile communication device 18 assigned to or otherwise carried by the employee, and the like. In one embodiment, the communication information (CI) may be or include the telephone number of the employee's mobile communication device 18. In other embodiments, the communication information (CI) may be or include a serial number, electronic identification code or other communication identifier associated with the employee's mobile communication device 18. In still other embodiments, the communication information (CI) may be or include, in place of or in addition to a telephone number or communication identifier of the employee's mobile electronic device, one or more other unique mobile electronic device identification codes that identify the specified mobile electronic device 18 for purposes of wireless communication therewith. Any such employee information is illustratively associated, e.g., linked or mapped, in the employee data 410 such that the processor 50 may be configured to search employee records within the employee data 406 according to any employee identifier.

The store location data 408 in the server database 402 illustratively has stored therein reference location information identifying various physical locations within each brick-and-mortar location 25. In some embodiments, the store location data 408 may alternatively or additionally include physical and/or product location information identifying various product display areas or other physical locations within the brick-and-mortar location 25. In still other embodiments, the store data 408 may alternatively or additionally include topographical map, planogram or other such data, some or all of which may be in graphical form, corresponding to one or more locations or areas within each of the brick-and-mortar locations 25.

The PID data 410 illustratively has stored therein PID identity information for each position identification device 26₁-26_{N} in the retail enterprise 11 as well as additional information from which the processor 50 can determine, for each device 26₁-26_{N}, the identity of the brick-and-mortar location 25 at which each such device is located as well as the location or position within that brick-and-mortar location at which the wireless signal broadcasting device is located. In some embodiments, the PID location data 410 may illustratively contain information about each device 26₁-26_{N} in the retail enterprise 11 including, for example, unique identification codes (UID) of each PID provided in the form of a wireless signal broadcasting device 26₁-26_{N}. In some embodiments, the PID location data 410 may include additional information including, for example, but not limited to, positional information corresponding to the coordinates of some or all of the PIDs which are embodied as wireless signal broadcasting devices 26₁-26_{N} of the retail enterprise 11 and/or of one or more brick-and-mortar locations thereof, relative to one or more sets of base coordinates.

The product/inventory location data 412 illustratively has stored therein location information identifying locations of merchandise displayed for sale within each brick-and-mortar location 25.

The customer purchase history data illustratively includes a history for each EMS customer member and has stored therein historical information relating to the products and/or services purchased by the customer member over time. In some embodiments, the database also includes crowd source assistance data 416 which illustratively includes information relating to customers currently in each of the stores 25₁-25_{L}, and their status as it relates to their availability to act as in-store customer assistance volunteers.

The environment 400 of the main server 12 further includes an EMS module 420 and a communication module 422. The EMS module 420 is configured to control and manage EMS-related activity of shopper members of the EMS program. The communication module 422 is configured, in a conventional manner, to control and manage all communications between the main server 12 and the local hub servers 22 in embodiments that include the local hub servers 22, and to control and manage all communications between the main server 12 and all point-of-sale systems 24₁-24_{M}, in embodiments that do not include a local hub server 22. The communication module 422 is further configured, in a conventional manner, to control and manage all wireless communications conducted between the main server 12 and the mobile communication devices 16₁-16_{J} and 18₁-18_{K}.

The environment 400 of the main server 12 further illustratively includes a mobile customer assistance (MCA) processing module 440 which illustratively includes a mobile customer assistance (MCA) processing module 442, a customer MCA application module, and employee MCA application module and a customer locate module 448. The MCA processor module 432 is illustratively operable to manage and facilitate providing in-person assistance to customers requesting such in-person assistance while shopping at any of the brick-and-mortar enterprise locations 25₁-25_{L}, and is generally operable to manage and control information exchange with the customer mobile communication devices 16₁-16_{J} and with the employee mobile communication devices 18₁-18_{K} as the customer mobile communication devices 16₁-16_{J} execute the MCA application 214 and the employee mobile communication devices 18₁-18_{K} execute the MCA application 312. One example embodiment of a process executed by MCA processing module 442 is illustrated in FIG. 6, and such a process will be described in detail hereinafter.

The customer MCA application module 444 illustratively contains the MCA application 214 illustrated and described with respect to FIG. 2. Example embodiments of processes executed by the processor 214 of the customer mobile communication devices 16₁-16_{J} according to the MCA application 214 are illustrated in FIGS. 6 and 8, and such processes will be described in detail hereinafter.

The employee MCA application module 446 illustratively contains the MCA application 312 illustrated and described with respect to FIG. 3. Example embodiments of processes executed by the processor 312 of the employee mobile communication devices 18₁-18_{K} according to the MCA application 312 are illustrated in FIGS. 6 and 8, and such processes will be described in detail hereinafter.

The customer locate module 448 is illustratively operable to control and manage a process for locating and tracking a customer within any of the brick-and-mortar enterprise locations 25₁-25_{L} that has requested in-person retailer assistance. An example embodiment of a process executed by the customer locate module 448 is illustrated in FIG. 8, and such a process will be described in detail hereinafter.

Referring now to FIG. 5, a simplified diagram is shown of a communications framework for detecting by customer mobile communication devices 16₁-16_{J} of wireless signals produced by any of the plurality of wireless signal broadcasting devices 26₁-26_{N} located with and/or throughout any of the plurality of brick-and-mortar enterprise locations 25₁-25_{L}, for conducting wireless communications between the customer mobile communication devices 16₁-16_{J} and the main server 12 of the retail enterprise 11, and for conducting wireless communications between the main server 12 and any of the enterprise mobile communication devices 18₁-18_{K}. As described hereinabove with respect to FIG. 1, each of the wireless communication devices 26₁-26_{N} fixedly located in any of the brick-and-mortar enterprise locations is operable to broadcast one or more unique wireless identification signals. In some embodiments, the unique identification signals distinguish each particular wireless communication device 26 from others of the wireless communication devices 26₁-26_{N} located at the same brick-and-mortar enterprise location, and in other embodiments also from all others of the wireless communication devices 26₁-26_{N} within the retail enterprise 11. At some point, while the wireless communication devices 26₁-26_{N} are broadcasting one or more unique wireless signals, a customer carrying the customer's the mobile communication device 16 may approach a location at which at one or more of the wireless communication devices 26₁-26_{N} are positioned. This scenario is depicted in FIG. 5 which illustrates one such wireless communication device 26, e.g., a wireless signal broadcasting device, mounted or otherwise placed in a fixed position within one of the brick-and-mortar enterprise locations 25₁-25_{L} and broadcasting unique wireless signals, each of which are represented in FIG. 5 by the semi-circular dashed lines emanating outwardly from the wireless signal broadcasting device 26.

The wireless signal broadcasting device 26 illustrated in FIG. 5 is illustratively provided in the form of a conventional radio frequency broadcasting beacon communicatively coupled to the main server 12 via the private network 20 and, in the illustrated embodiment, via one of the local hub servers 22. The customer's mobile electronic device 16 and the main server 12 are each illustratively configured to communicate wirelessly with each other via the public network 14. Likewise, an enterprise mobile communication device 18 and the main server 12 are shown each illustratively configured to communicate wirelessly with each other via the public network 14. In other embodiments, the main server 12 may wirelessly communicate with the various enterprise mobile computing devices 18₁-18_{K} via a private wireless network or via the public network 14 in accordance with a private or secure communication protocol. In some embodiments, one or more of the brick-and-mortar enterprise locations 25₁-25_{L} may illustratively implement one or more local or wide area networks for the purpose of providing or enhancing wireless communication access by customer mobile communication devices 16₁-16_{J}, and/or by enterprise mobile computing devices 18₁-18_{K}, to the public network 14 within and throughout the vicinity of one or more of the brick-and-mortar enterprise locations 25₁-25_{L}.

In any case, as the customer's mobile communication device 16 approaches the fixed location of the wireless signal broadcasting device 26, the customer's mobile communication device 16 enters the broadcast range of the wireless signal broadcasting device 26 as depicted in FIG. 5. When within the broadcast range of the wireless signal broadcasting device 26, the customer's mobile communication device 16 is able to detect the unique identification signals being broadcast by the wireless signal broadcasting device 26. Illustratively, the broadcast range of the wireless signal broadcasting device 26 is sufficiently large, wide and/or oriented so as to be detectable by customers' mobile communication devices 16₁-16_{J} during normal movement of customers carrying their mobile communication devices 16₁-16_{J} in the brick-and-mortar enterprise locations 25₁-25_{L}, while is at the same time sufficiently small, narrow and/or oriented so as to provide a desired amount or degree of resolution in determining the location of a customer's mobile communication device 16 relative to one or a subset of the wireless signal broadcasting devices 26₁-26_{N} positioned within any of the brick-and-mortar enterprise locations 25₁-25_{L}, as will be described in greater detail hereinafter with respect to FIG. 7. Generally, the broadcast range of any of the wireless signal broadcasting devices 26₁-26_{N} positioned within any of the brick-and-mortar enterprise locations 25₁-25_{L} should be understood to be defined by an area relative to the wireless signal broadcasting device 26 within which the signal strength of wireless signals broadcast thereby is sufficient to be detected by the communication circuitry 38 of the customer mobile communication devices 16₁-16_{J}, and outside of which the signal strength of wireless signals broadcast thereby is undetectable by the communication circuitry 38 carried by the customer mobile communication devices 16₁-16_{J}. As used in the previous sentence, the term “undetectable” should be understood to mean any of indistinguishable by the communication circuitry 38 of the customer mobile communication devices 16₁-16_{J} from background electromagnetic noise, distinguishable by the communication circuitry 38 of the customer mobile communication devices 16₁-16_{J} from background electromagnetic noise but not decodable by the communication circuitry 38 of the customer mobile communication devices 16₁-16_{J} or distinguishable by the communication circuitry 38 of the customer mobile communication devices 16₁-16_{J} from background electromagnetic noise but not decodable by communication circuitry of any electronic device or system to which the communication circuitry 38 of the customer mobile communication devices 16₁-16_{J} may transmit or otherwise relay the wireless broadcast signal(s). In any case, the general communication framework illustrated in FIG. 5 is used in the process 600 illustrated and described below with reference to FIG. 6 for detecting by customer mobile communication devices 16₁-16_{J} of wireless signals produced by any of the plurality of wireless signal broadcasting devices 26₁-26_{N} located with and/or throughout any of the plurality of brick-and-mortar enterprise locations 25₁-25_{L}, for conducting wireless communications between the customer mobile communication devices 16₁-16_{J} and the main server 12 of the retail enterprise 11, and for conducting wireless communications between the main server 12 and any of the enterprise mobile communication devices 18₁-18_{K}.

Referring now to FIG. 6, a simplified flow diagram is shown of an embodiment of a process 600 for providing in-person retailer assistance to customers in a retail environment. As indicated by the framework of the process 600 illustrated in FIG. 6, a portion of the process 600, i.e., the portion to the left of the left-most vertical line and centered under the heading “CMCD,” illustratively represents one or more software applications executed by the processor 200 of a customer's mobile communication device 16, i.e., one of the mobile communication devices 16₁-16_{J} associated in the customer account data 404 with a customer member of the EMS program. In one embodiment, this portion of the process 600 is or includes the MCA application module 214 stored in the memory 204 (and/or data storage 206) of the customer's mobile communication device 16 (see FIG. 2) in the form of instructions executable by the processor 200 of the customer's mobile communication device 16. The process steps of this portion of the process 600 will be described below for purposes of this disclosure as being executed by the processor 200 of the customer's mobile communication device 16. In the following description, a customer's mobile communication device 16 may be referred to as “CMCD,” and will be understood to refer generally to one of the mobile communication devices 16₁-16_{J} associated in the customer account data 404 with one of the customer members of the EMS program.

Another portion of the process 600, i.e., the portion between the left-most vertical line and the centrally-positioned vertical line, and centered under the heading “Wireless signal broadcasting devices,” does not necessarily represent a portion of the process 600 that is stored in a memory of any system or server in the form of instructions executable by a processor, but rather represents operation of the various wireless signal broadcasting devices 26₁-26_{N} illustrated and described with respect to FIG. 1 as such operation relates to the broadcast of wireless signals as described hereinabove.

Yet another portion of the process 600, i.e., the portion to the right of the centrally-positioned line and the right-most vertical line, and centered under the heading “Main Server,” illustratively represents one or more software applications executed by the processor 50 of the main server 12. In one embodiment, this portion of the process 600 is or includes the MCA processing module 442 stored in the mobile customer assistance (MCA) module 440 (see FIG. 4) in the form of instructions executable by the processor 50 of the main server 12. The process steps of this portion of the process 600 will be described below for purposes of this disclosure as being executed by the processor 50 of the main server. In some alternate embodiments, e.g., that may or may not include a main server 12, this portion of the process 600 may alternatively be stored in the memory 34 (and/or data storage 36) of one or more of the local servers 22 in the form of instructions executable by the processor 30 of the one or more local servers 22, stored in the memory of one of the point-of-sale systems 24₁-24_{M} within one or more of the brick-and-mortar enterprise locations 25₁-25_{L} in the form of instructions executable by a processor associated with any such point-of-sale system 24₁-24_{M}, and/or stored in a memory and executable by a processor of another system external to or supplemental to the system 10 illustrated FIG. 1.

Still another portion of the process 600, i.e., the portion to the right of the right-most vertical line and centered under the heading “EMCD(s),” illustratively represents one or more software applications executed by the processor 300 of one or more enterprise employee mobile communication devices 18, i.e., one or more mobile communication devices 18₁-18_{K} each associated with and carried by a different employee of the retail enterprise 11. In one embodiment, this portion of the process 600 is or includes the MCA application module 312 stored in the memory 304 (and/or data storage 306) of the enterprise employee's mobile communication device 18 (see FIG. 3) in the form of instructions executable by the processor 300 of the enterprise employee's mobile communication device 18. The process steps of this portion of the process 600 will be described below for purposes of this disclosure as being executed by the processor 300 of the customer's mobile communication device 16, although in some alternate embodiments one or more such process steps may alternatively be executed by the processor 50 of the main server, the processor 30 of one or more of the local hub servers 22, a processor of one or more of the point-of-sale systems 24₁-24_{M} and/or a processor of another system external to or supplemental to the system 10 illustrated FIG. 1. In the following description, an enterprise employee's mobile communication device 18 may be referred to as “EMCD,” and will be understood to refer generally to one of the mobile communication devices 18₁-18_{K} carried by an employee of the retail enterprise 11.

It will further be understood that portions of the process 600 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

For purposes of the following description of the process 600, in-person assistance provided by an employee of the retail enterprise 11 to a customer located in one of the brick-and-mortar enterprise locations 25₁-25_{L}, upon request by the customer, will be described as taking place at one of the brick-and-mortar enterprise locations 25₁-25_{L}. In this regard, reference will be made hereinafter to “the brick-and-mortar location 25,” “a customer,” “the customer,” “an employee,” “the employee” and “employees.” It will be understood that the terms “a customer” and “the customer” refer to a customer-member of the EMS program described above or to a customer-member of, or customer-participant in, some other customer-service or other enterprise-based program in which some information about each of a plurality of customers of the retail enterprise 11, including at least the customer's identity and communication information (CI) associated with the customer's mobile communication device 16, i.e., a telephone number, electronic identification code or other contact information, which identifies the customer's mobile communication device 16 for purposes of wirelessly communicating therewith, is stored in the customer account data 404 of the database 402 or other database accessible to and by the processor 50 of the main server 12. It will further be understood that the terms “an employee” and “the employee” refer to a temporary or full-time employee of, or contractor for, the retail enterprise 11, and that the term “employees” refers to two or more temporary or full-time employees of, or contractors for, the retail enterprise 11. Further still, it will be understood that the phrase “the brick-and-mortar location 25” should not be considered to limit the process 600 to any particular one of the various brick-and-mortar enterprise locations 25₁-25_{L}, but rather should be understood to apply generally to the process 600 being carried out with respect to, and generally between, a customer and one or more employees at any one of the brick-and-mortar enterprise locations 25₁-25_{L}.

In the process 600 illustrated in FIG. 6, item 602 identifies an action taken by a customer of the retail enterprise 11 while located within one of the brick-and-mortar enterprise locations 25₁-25_{L} when the customer desires to seek in-person help from and/or to speak in-person with an employee of the retail enterprise 11 at the brick-and-mortar location 25. In this regard, the customer activates, at 602, the MCA application 212 stored on the customer's mobile communication device 16, e.g., by manually activating the application 212 in a conventional manner. In some instances, the MCA application 212 may already be running or operating on the CMCD 16 and in such instances item 602 may be skipped. Following item 602, or if item 602 is skipped because the MCA application 212 is already running on the CMCD 16, the processor 200 of the CMCD 16 is operable at 604, under the direction of the MCA application 212, to execute a process for controlling the display 218 to produce a graphic user interface (GUI) via which the customer can request customer assistance.

Referring now to FIG. 8, a simplified flow diagram is shown of an embodiment 800 of the process executed at step 604 of the process 600 illustrated in FIG. 6. The process 800 is illustratively stored in the memory 204 of the CMCD 16 and is executed by the processor 200 of the CMCD 16. The process 800 begins at step 802 where the processor 200 is operable to control the display 218 to produce a graphic user interface (GUI) which includes a selectable enterprise employee contact element, e.g., in the form of a “help request” or other suitable element identifier. The customer may manually begin the process 600 illustrated in FIG. 6 by selecting the contact element, e.g., the “help request” element, in or on the GUI displayed on the display 218, e.g., via a conventional keypad, touch-screen or other input device. Illustratively, the process 800 includes a step 822 which loops to the beginning of step 802 until the “help request” element is selected, and thereafter the process 800 terminates and is returned to step 604 of the process 600 illustrated in FIG. 6.

In some embodiments, the process 800 includes a step 804 following step 602 which is illustrated in dash-line representation to indicate that step 804 is optional in some embodiments. In embodiments which include step 804, the processor 200 is operable at step 806 to control the display 220 to display a number of selectable help source GUI elements. In one embodiment, the selectable help source elements include store employee element, SE, and a crowd source element, CS. If the former is selected, at step 808 the processor 200 identifies store employee as the help source selection, and if the latter is selected, at step 810 the processor 200 identifies crowd source as the help source selection. In the former case, the customer has requested assistance from a store employee, and in the latter case the customer has requested assistance from one or more in-store customer volunteers as will be described in detail herein.

In some embodiments, the process 800 includes a step 806 which is illustrated in dashed-line representation to indicate that step 806 is optional in some embodiments. In embodiments which include step 806, the processor 200 is operable at step 816 to control the display 220 to display one or more selectable help information GUI elements. Such help information elements may include selectable elements which further define what the customer desires assistance with. Examples of such help elements include, but are not limited to, product advice, one or more items out of stock, product color, product size, etc. If any such help information GUI elements is/are selected at step 818, the processor 200 is operable to capture such help information elements, HI, at step 820, and otherwise the process 800 terminates and returns to step 604 of the process 600 illustrated in FIG. 6.

Referring again to FIG. 6, in the process 600 illustrated in FIG. 6, item 608 identifies action taken by the plurality of wireless signal broadcasting devices 26₁-26_{N} positioned in or at various locations within and/or throughout the brick-and-mortar enterprise location 25. In some embodiments, each of the plurality of wireless signal broadcasting devices 26₁-26_{N} operate to continuously or continually broadcast wireless identification signals, each of which carry decodable information in the form of a unique identification code (UID) as described hereinabove with respect to FIG. 1. In some embodiments, such signals may be periodically or non-periodically broadcast by the wireless signal broadcasting devices 26₁-26_{N}, and in other embodiments some of the wireless signal broadcasting devices 26₁-26_{N} may periodically broadcast wireless signals and others of the wireless signal broadcasting devices 26₁-26_{N} may broadcast wireless signals non-periodically. In still other embodiments, one or more of the wireless signal broadcasting devices 26₁-26_{N} may sometimes periodically broadcast wireless signals and at other times broadcast wireless signals non-periodically. In any case in embodiments in which the wireless signal broadcasting devices 25₁-25_{L} continuously or continually broadcast wireless signals, the process advances, in response to customer selection of the contact element, e.g., the “help request” element, displayed on the display 218 at step 604, to step 606 where the wireless communication circuitry 216 of the CMCD 16 is operable to detect any such broadcast wireless signals within the broadcast range of which the CMCD 16 is located as described above with respect to FIG. 5.

In some alternative embodiments, one or more of the wireless signal broadcasting devices 26₁-26_{N} may be selectively operable to periodically or non-periodically broadcast wireless identification signals. In such embodiments, one or more of the wireless signal broadcasting devices 26₁-26_{N} may, for example, be responsive to one or more control signals produced by the processor 50 of the main server, the processor 30 of one of the local hub servers 22, a processor associated with one or more of the point-of-sale systems 24₁-24_{M} located in the brick-and-mortar location 25 and/or other processor(s) associated with the one or more devices 26₁-26_{N}, to selectively wake up or otherwise activate and begin broadcasting wireless identification signals and to selectively deactivate and cease broadcasting wireless signals. In some embodiments, the brick-and-mortar location 25 may include a plurality of conventional proximity or motion-detecting sensors within and/or throughout the brick-and-mortar location, e.g., one or more such sensors at or near one or more of the wireless signal broadcasting devices 26₁-26_{N}, and production of such control signals may be triggered by proximity or motion signals produced by such sensors. In other embodiments, production of such control signals may, for example, be triggered by, e.g., in response to, customer selection of the contact element, e.g., the “help request” element, displayed on the display 218 at 604. In one example such embodiment, the process 600 may be modified to include one or more steps via which the processor 200 of the CMCD 16 wirelessly transmits one or more trigger signals to the main server 12 in response to customer selection of the contact element, e.g., the “help request” element, displayed on the display 218 at 604, and the processor 50 of the main server 12 may, in turn, be responsive to receipt of the one or more trigger signals received by the main server 12 from the CMCD 16 to produce the aforementioned control signals to wake up and activate one or more of the wireless signal broadcasting devices 26₁-26_{N}. Those skilled in the art will recognize that any modifications required to implement and integrate one or more steps of either or both of the foregoing alternate embodiments into the process 600 would be a mechanical step for a skilled programmer, and that such alternate embodiments therefore fall within the scope of this disclosure.

As used hereinafter, the term “in-range” will be understood to refer to one or more of the wireless communication devices 26₁-26_{N} within the broadcast range of which a customer's mobile communication device 16 is presently located. Thus, if in the example illustrated in FIG. 5 the outer-most semi-circular dashed line emanating from the wireless signal broadcasting device 26 represents the broadcast range of the wireless signal broadcasting device 26, the wireless signal broadcasting device 26 is an in-range wireless signal broadcasting device relative to the customer mobile communication device 16. If the customer mobile communication device 16 depicted in the example illustrated in FIG. 5 is moved downwardly such that the outer boundary of the customer mobile communication device 16 is located below the outer-most semi-circular dashed line emanating from the wireless signal broadcasting device 26, the wireless signal broadcasting device 26 is not an in-range wireless signal broadcasting device relative to the customer mobile communication device 16.

Referring again now to FIG. 6, the processor 200 is responsive at step 606 to the customer's manual selection of the contact element, e.g., the “help request” element, displayed on the display 218 to detect the unique identification signals wirelessly broadcast by any in-range ones of the plurality of wireless signal broadcasting devices 26₁-26_{N} at the time of execution of step 606. Following step 606, the process 600 advances to step 610 where the processor 600 of the customer's mobile communication device 16 is operable to transmit one or more wireless signals to the main server 12, e.g., to control the communication circuitry 216 in the device 16 to wirelessly transmit one or more signals to the main server 12 via the public network 14 as illustrated in FIG. 5. The one or more wireless signals illustratively contain(s) the unique identification (UID) of each in-range wireless signal broadcasting device 26₁-26_{N}, and also illustratively contain(s) an identification of the customer's mobile communication device 16. The identification of the customer's mobile communication device 16 may be, for example, the communication information (CI), e.g., cellular telephone number and/or other communication identifier, which identifies the customer's mobile communication device 16 to the main server 12 for the purpose of communicating information from the main server 12 back to the customer's mobile communication device 16. In some embodiments, the one or more wireless signals transmitted by the customer's mobile communication device 16 may further include the “help request” or identifier thereof selected by the customer at step 606.

In one embodiment, the processor 200 of the customer's mobile communication device 16 is operable at step 606 to process the wireless broadcast signal broadcast by each in-range wireless signal broadcasting device 26₁-26_{N} to determine therefrom the UID of each such in-range wireless signal broadcasting device 26₁-26_{N}, and to include each such UID in the one or more wireless signals transmitted by the customer's mobile communication device 16 to the main server 12 at step 606. In other embodiments, the processor 200 may be operable at step 606 to process one or more of the wireless broadcast signals broadcast by in-range ones of the wireless signal broadcasting devices 26₁-26_{N} and detected by the customer's mobile communication device 16, and to include in the in the one or more wireless signals transmitted by the customer's mobile communication device 16 to the main server 12 at step 610 only the raw signal content of one or more of the wireless broadcast signals broadcast by in-range ones of the wireless signal broadcasting devices 26₁-26_{N}. In such embodiments, the processor 50 of the main server 12 may be operable to thereafter process the raw signal content transmitted thereto by the customer's mobile communication device 16 to determine therefrom the UID of each corresponding in-range wireless signal broadcasting device.

Following step 610, the main server 12 is operable at step 612 to receive the one or more wireless signals transmitted by the customer's mobile communication device 16 at step 610, and the processor 50 of the main server 12 is thereafter operable at step 614 to process the UIDs contained therein to determine the identities and locations of each of the in-range ones of the wireless signal broadcasting devices 26₁-26_{N} detected by the customer's mobile communication device 16 at step 606, and to process the resulting wireless signal broadcasting device location data to determine the identity of the one of the plurality of brick-and-mortar enterprise locations 25₁-25_{L} in which the detected wireless signal broadcasting device(s) 26 is/are located, and the location of the customer's mobile communication device 16 within the identified brick-and-mortar location.

As described briefly above with respect to FIG. 4, the wireless signal broadcasting device location data 410 in the server database 402 illustratively has stored therein wireless signal broadcasting device identity information for each wireless signal broadcasting device 26₁-26_{N} in the retail enterprise 11 as well as additional information from which the processor 50 can determine, for each wireless signal broadcasting device 26₁-26_{N}, the identity of the brick-and-mortar location 25 at which each such wireless signal broadcasting device is located as well as the location or position within that brick-and-mortar location at which the wireless signal broadcasting device is located. In one embodiment, for example, the wireless signal broadcasting device identity information stored in the wireless signal broadcasting device location data 410 of the database 402 includes the UIDs for each of the wireless signal broadcasting devices 26₁-26_{N} in the retail enterprise, and each such UID includes or is associated with, e.g., linked to, mapped to, or otherwise identified with, a brick-and-mortar location identifier (BMID), e.g., in the form of a designation number or code, which identifies the corresponding one of the brick-and-mortar enterprise locations 25₁-25_{L} in which the corresponding wireless signal broadcasting device 26 is located, and further includes or is associated with, e.g., linked to, mapped to, or otherwise identified with, a wireless signal broadcasting device location identifier (BID), e.g., in the form of a designation number or code, which identifies the location of the corresponding wireless signal broadcasting device 26 within the brick-and-mortar enterprise location 25₁-25_{L} identified by BMID. In some embodiments, the brick-and-mortar location identifiers, BMID, are illustratively stored in the form of store or outlet numbers or codes, such as store 10 or outlet JS-3. In other embodiments, the brick-and-mortar location identifiers may include additional information such as city, state or country identifier or the like.

In some embodiments, the wireless signal broadcasting device location identifiers, BID, are illustratively stored in the form of location coordinates relative to a base or reference set of coordinates. In some alternate embodiments, the wireless signal broadcasting device location identifiers, BID, may be stored in the form of one or more location codes identifying one or more of an aisle, shelf, section, merchandise area and/or other identifier which identifies a particular location within a corresponding one of the plurality of brick-and-mortar locations 25₁-25_{L}. For example, one particular BID may include two location codes 17, 4 which identify the location of the corresponding wireless signal broadcasting device to be aisle 17, section 4. In such embodiments, the location codes may be further mapped to physical location identifiers each of which identify a physical location within a corresponding one of the plurality of brick-and-mortar locations 25₁-25_{L}. For example, one particular wireless signal broadcasting device location identifier, BID, may include two location codes FR and IC, and such codes may be mapped to corresponding physical location identifiers which identify the location of the wireless signal broadcasting device as freezer section, ice cream section. Such physical location identifiers may be stored in the wireless signal broadcasting device location data 410 or alternatively in the brick-and-mortar location data 408. In other alternative embodiments, the location codes may be omitted and the wireless signal broadcasting device location identifiers, BID, may be stored in the wireless signal broadcasting device location data 410 in the form of one or more physical location identifiers. In still other alternative embodiments, the UIDs stored in the wireless signal broadcasting device location data 410 may be associated with, e.g., mapped to, one or more location codes and/or one or more physical identifiers stored in another database area such as the brick-and-mortar location data 408. Other techniques for storing and/or processing wireless signal broadcasting device identity information to determine the relative or precise location of any of the wireless signal broadcasting devices 26₁-26_{N} within any of the brick-and-mortar enterprise locations 25₁-25_{L} will occur to those skilled in the art, and it will be understood that any such other techniques are contemplated by this disclosure.

In any of the foregoing embodiments, the processor 50 is illustratively operable at step 614 to process each UID by searching for a matching UID stored in the wireless signal broadcasting device location data 410, determining the BMID associated in the wireless signal broadcasting device location data 410 or other database with the matched UID and determining therefrom the identity of the corresponding one of the brick-and-mortar enterprise locations 25₁-25_{L} at which the corresponding wireless signal broadcasting device 26 is located, and determining the BID associated in the wireless signal broadcasting device location data 410 or other database with the matched UID and determining therefrom the location of the corresponding wireless signal broadcasting device 26 within the one of the brick-and-mortar enterprise locations 25₁-25_{L} identified by BMID.

The processor 50 is further operable at step 614 to process the identified brick-and-mortar location 25 and the wireless signal broadcasting device location information for each UID received at step 612 from the customer's mobile communication device 16 to determine, e.g., estimate, the location of the customer's mobile communication device 16 relative to one or more reference locations within the identified brick-and-mortar location 25.

As described briefly above with respect to FIG. 4, the brick-and-mortar location data 408 in the server database 402 illustratively has stored therein reference location information identifying various physical locations within each brick-and-mortar location 25, and the product/inventory location data 412 illustratively has stored therein location information identifying locations of merchandise displayed for sale within each brick-and-mortar location 25. In one embodiment, such information is illustratively stored in the form of location coordinates within a corresponding brick-and-mortar location 25 relative to at least one set of base location coordinates. In such embodiments, for example, each such set of location coordinates may be mapped to or associated with in the data 408 a corresponding location identifier such as one or any combination of an aisle, section, shelf, product area or the like. In other embodiments, the wireless signal broadcasting device location information stored in the wireless signal broadcasting device location data 410 may be pre-mapped or associated with one or more corresponding ones of the reference coordinates and/or location identifiers. In any case, the processor 50 is operable in any such embodiment to process the identified brick-and-mortar location 25, the wireless signal broadcasting device location information for each UID received at step 612 from the customer's mobile communication device 16 at step 612 and the reference locations and/or location identifiers to estimate the position of the location of the customer's mobile communication device 16 within the identified brick-and-mortar location 25. Several examples of the one or more embodiments of steps 606-614 of the process 600 described above are illustrated in FIG. 7.

Referring now to FIG. 7, a top-plan view is shown of an example layout of a merchandise area 28 within a brick-and-mortar location 25 in which three conventional shelving units 700, 702 and 704 are mounted. A first aisle, AISLE1, is defined in the space between the shelving units 700 and 702, a second aisle, AISLE2, is defined in the space between the shelving units 702 and 704, and a third aisle, AISLE3, is identified in the space between the shelving unit 704 and a wall of the brick-and-mortar location 25. Distributed along each of the shelving units, e.g., mounted to or within the ceiling of the brick-and-mortar location 25, to the tops of the shelving units, or to other structure(s) within the brick-and-mortar location 25, are a set of wireless signal broadcasting devices. For example, spaced along shelving unit 700 are four such wireless signal broadcasting devices 26₁-26₄, spaced along the shelving unit 702 are four wireless signal broadcasting devices 26₅-26₈ and spaced along the shelving unit 704 are four additional wireless signal broadcasting devices 26₉-26₁₂. Each of the shelving units 702, 704 is illustratively divided, structurally or non-structurally, into nine sequential sections 1-9, and each of the four wireless signal broadcasting devices 26₅-26₈ and 26₉-26₁₂ is centrally located relative to a different one of the sections as shown, e.g., sections 2, 4, 6 and 8 respectively. In the example illustrated in FIG. 7, each of the wireless signal broadcasting devices 26₅-26₁₂ is activated and operating to broadcast wireless identification signals as indicated by the dashed-line circles emanating from each, and the outermost dashed-line circle about each wireless signal broadcasting device represents the broadcast range thereof.

A first customer's mobile communication device 16₁ is shown in FIG. 7 as being located in aisle 2 and positioned such that only wireless signal broadcasting devices 26₅ and 26₉ are in-range wireless signal broadcasting devices, i.e., the customer's mobile communication device 16₁ is positioned such that it can detect wireless identification signals only by wireless signal broadcasting devices 26₅ and 26₉. Accordingly, the processor 200 of the customer's mobile communication device 16₁ is operable at step 606 to detect the wireless identification signals broadcast by wireless signal broadcasting devices 26₅ and 26₉, and at step 610 to wirelessly transmit the UIDs of wireless signal broadcasting devices 26₅ and 26₉ to the main server 12. The processor 50 of the main server 12 is operable to receive the UIDs of the wireless signal broadcasting devices 26₅ and 26₉ at step 612, and at step 614 the processor 50 is illustratively operable to first compare the received UIDs to UIDs stored in the wireless signal broadcasting device location data 410. When the matching UIDs are found in the wireless signal broadcasting device location data 410, the processor 50 is further operable to access the brick-and-mortar identifiers (BMID) associated, e.g., in the wireless signal broadcasting device location data 410, with the matched UIDs and determine from the accessed BMIDs that the wireless signal broadcasting devices 26₅ and 26₉ are located in the brick-and-mortar location 25. Thereafter, the processor 50 of the main server 12 is operable at step 612 to access the wireless signal broadcasting device location identifiers (BID) associated, e.g., in the wireless signal broadcasting device location data 410, with the matched UIDs and determine from the accessed BIDs that the wireless signal broadcasting device 26₅ is located centrally above section 2 of the shelving unit 702 and the wireless signal broadcasting device 26₉ is located centrally above section 2 of the shelving unit 704. Thereafter, the processor 50 is illustratively operable at step 612 to estimate, based on the locations of the wireless signal broadcasting devices 26₅ and 26₉ within the brick-and-mortar location 25, that the customer's mobile communication device 16₁ is located in aisle 2, section 2. Alternatively or additionally, the processor 50 may be operable at step 612 to estimate, based further on the broadcast ranges of the wireless signal broadcasting devices 26₅ and 26₉, that the customer's mobile communication device 16₁ is located centrally within aisle 2 since it is only in the central region of aisle 2 that the broadcast ranges of the wireless signal broadcasting devices 26₅ and 26₉ overlap as illustrated in FIG. 7. Alternatively or additionally still, in embodiments in which aisle 2, section 2 is mapped to one or more merchandise identifiers, e.g., such that section 2 is coffee section, the processor 50 may be operable at step 614 to estimate that the customer's mobile communication device 16₁ is located in the coffee section, or in the coffee section of aisle 2.

Similarly, steps 604-614 of the process 600 may be applied to the example illustrated in FIG. 7 to estimate that the customer's mobile communication device 16₂ is located centrally in aisle 2, section 5 since it is only in the central region of aisle 2, section 5 that the broadcast ranges of the wireless signal broadcasting devices 26₆, 26₇, 26₁₀ and 26₁₁ overlap as illustrated in FIG. 7. Likewise, steps 604-614 may be applied to the example illustrated in FIG. 7 to estimate that the customer's mobile communication device 16₃ is located in aisle 2, section 7 and next to the shelving unit 702 since it is only in this region of aisle 2 that the broadcast ranges of the wireless signal broadcasting devices 26₇ and 26₈ overlap and that neither overlaps with the broadcast range of the wireless signal broadcasting device 26₁₁ or the broadcast range of the wireless signal broadcasting device 26₁₂, as further illustrated in FIG. 7. While it will be recognized that such demonstrated resolution in estimating the locations of customer's mobile communication devices 16 may be more than is needed in some implementations of the system 10, it should be further recognized that such resolution may be desirable in other implementations such as in highly populated areas with substantial customer traffic.

Referring again to FIG. 6, the process 600 advances from step 614 to step 616 where the processor 50 is illustratively operable to process the communication information, CI, to determine the identity of the customer associated with the customer's mobile communication device 16 which transmitted the help request. As described briefly above with respect to FIG. 4, the customer account data 404 illustratively has stored therein information identifying the various customer-members of the EMS program including, for example the names, address and EMSIDs of the customer-members and the communication information, CI associated in the customer account data 404 with the customer name, or other customer identifier(s). In some embodiments, the customer account data 404 may further include one or more digital photographs of one or more of the customers, e.g., uploaded by customers into the customer account data 404 by the customers via the EMS web page or other data link. In such embodiments, one or more digital photographs of any customer may be associated, i.e., linked or mapped, to the customer identifier, e.g., customer name and/or to the customer's associated communication information, CI. In any case, the processor 50 is operable at step 616 to process the communication information, CI, transmitted to the main server 12 by the customer's mobile communication device 16 at step 610, to determine an identity of the customer associated with the customer's mobile communication device 16. In one embodiment, the processor 50 is illustratively operable to execute step 616 by comparing the wirelessly received communication information, CI, with communication information, CI, stored in the customer account data 410, and to then access the customer identity, e.g., customer name or other identifier, associated in the customer account data 410 with the matching communication information, CI.

In other embodiments, the processor 200 of the customer's mobile communication device 16 may be operable at step 610 to transmit a customer identifier, e.g., one or more sequences of unique codes uniquely identifying the customer, e.g., the customer's EMSID, in place of or in addition to the communication information, CI. In such embodiments, the customer account data 410 illustratively has matching customer identifiers stored therein and associated, e.g., mapped or linked, to corresponding customer names or other customer identifiers, and the processor 50 may be operable in such embodiments to execute step 616 by comparing the wirelessly received customer identifier with customer identifiers stored in the customer account data 410, and to then access the customer identity, e.g., customer name or other identifier, associated in the customer account data 410 with the matching customer identifier.

The process 600 advances from step 616 to step 618 where the processor 50 is operable to determine, e.g., from information carried by the wireless signal(s) received from the CMCD 16 at step 612, whether the customer has requested assistance from a store employee or crowd source help. If the former, the process 600 advances to step 620 where the processor 50 executes a store employee help process, and if the latter the process 500 advances to step 622 where the processor 50 executes a crowd source help process.

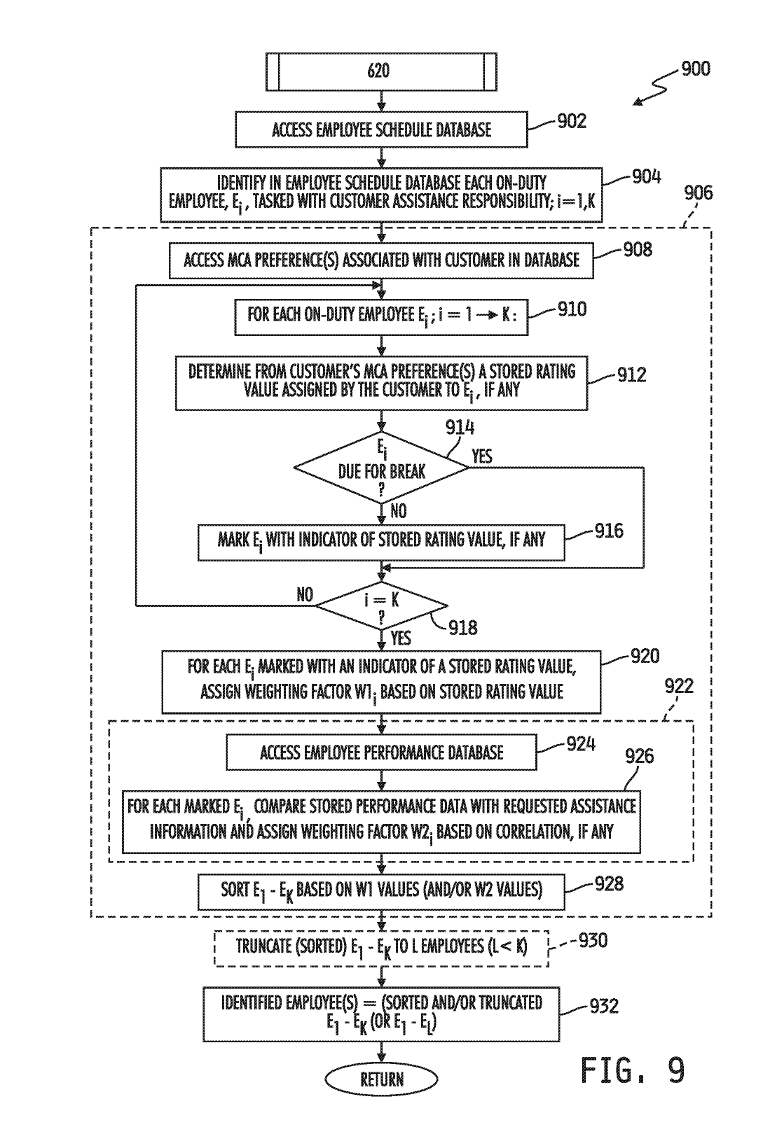

Referring now to FIG. 9, an embodiment 900 of the employee help process executed at step 620 of the process 600 is shown. Illustratively, the process 900 is stored in the MCA processing module 442 of the MCA module 440 in the form of instructions executable by the processor 50 of the main server 12. The process 900 illustratively begins at step 902 where the processor 50 is operable to access the employee schedule database 406, and thereafter at step 904 the processor 50 is operable to determine therefrom each employee, Eᵢ, currently working at the identified store 25 and available for and/or assigned the duty of, providing in-person customer assistance, where i=1, K and K is any positive integer. In some embodiments, the process 900 may include step 906, and step 906 is illustrated in FIG. 9 with dashed-line representation to indicate that step 906 is optional in some embodiments. In embodiments which include step 906, the processor 50 is operable at step 908 to access the one or more mobile customer assistance (MCA) preference(s) associated with the customer in the database 402. In accordance with step 906, the customer may establish ratings for store employees which have previously helped the customer, and such customer assigned ratings may be stored in a preferences portion of the customer account data 404, for example. In such embodiments, a rating value is stored in the customer account data 404 and linked to the customer's EMSID so that the processor 50 may use the customer rating values to inform the choice of stored employees to assist the customer. In this regard, the processor 50 is illustratively operable at steps 910 and 912 to determine for each on-duty employee, Eᵢ, a stored rating value, i.e., a rating value, if any, previously assigned by the customer to that employee based on the customer's previous experience with the employee. At steps 914 and 916, the processor 50 is operable to mark with an indicator of the customer's corresponding stored rating value each of the currently on-duty employees Eᵢ that are not on a scheduled break or due for one in the next several minutes. At step 918, the process 900 ensures that each of the K on-duty employees are processed with rating values, if any.

At step 920, the processor 50 is illustratively operable to assign a weighting factor, W1ᵢ, to each employee Eᵢ marked at step 916 with a stored rating value. Illustratively, the weighting factor, W1ᵢ assigned to each such employee is a function of that employees rating value such that employees with higher rating values receive higher weighting factors. In some embodiments, the process 900 may also include a step 922, and in such embodiments the processor 50 is operable at step 924 to access the employee performance database 406, and thereafter at step 926 the processor 50 is operable to compare, for each employee Eᵢ marked with a rating value assigned by the customer, performance data for that employee stored in the employee performance database 406 with the requested assistance information, HI, if any, and to assign a second weighting factor, W2ᵢ to each employee based on a correlation between the employee's performance data and the requested assistance information, if any. As with the weighting factors, W1ᵢ, the weighting factors W2ᵢ are higher for employees whose performance rates more highly for the type of help requested. As an example, which should not be considered limiting, if the type of help requested is for an out-of-stock item and employee E₂ has a high performance rating for such work, W2ᵢ will be a high weighting factor.

Following step 926, the process 900 advances to step 928 where the processor 50 is illustratively operable to sort the available employees, E₁-E_{K} based on either or both of the weighting factors W1ᵢ and W2ᵢ. Thereafter at step 930, the processor 50 is illustratively operable to truncate the sorted list of employees to a lesser number, L, such that at step 932 the processor 50 has a sorted and/or truncated list of identified employees to whom to forward the customer's help request.

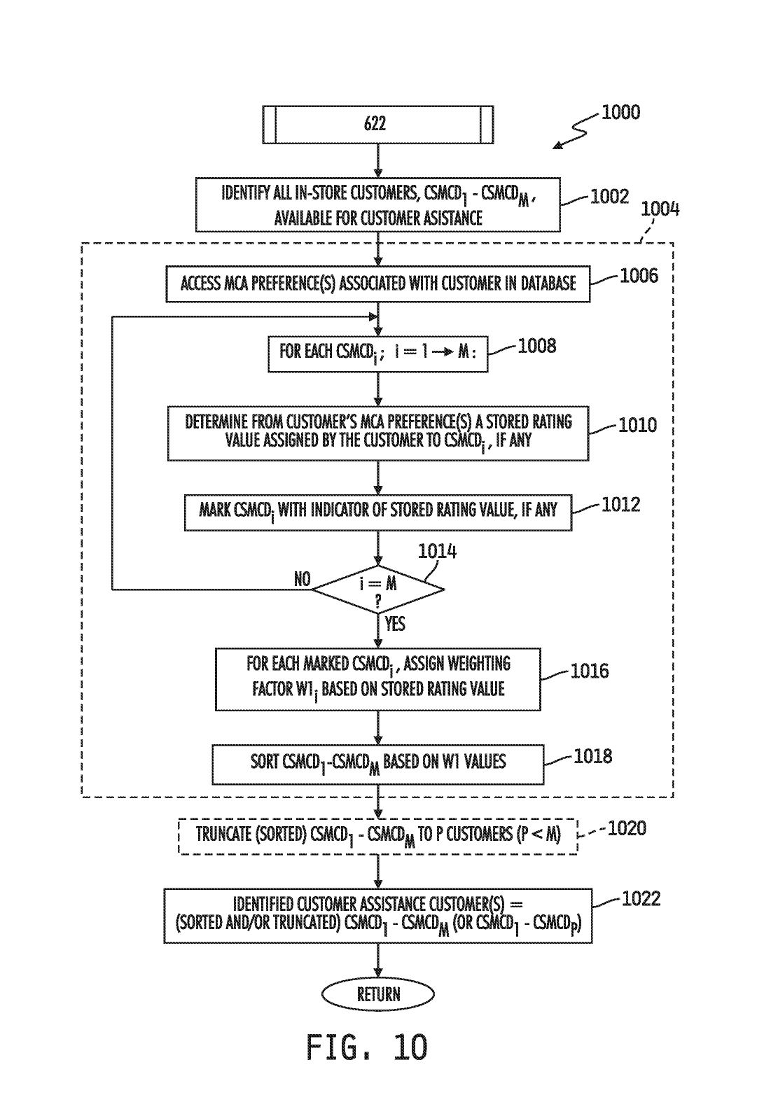

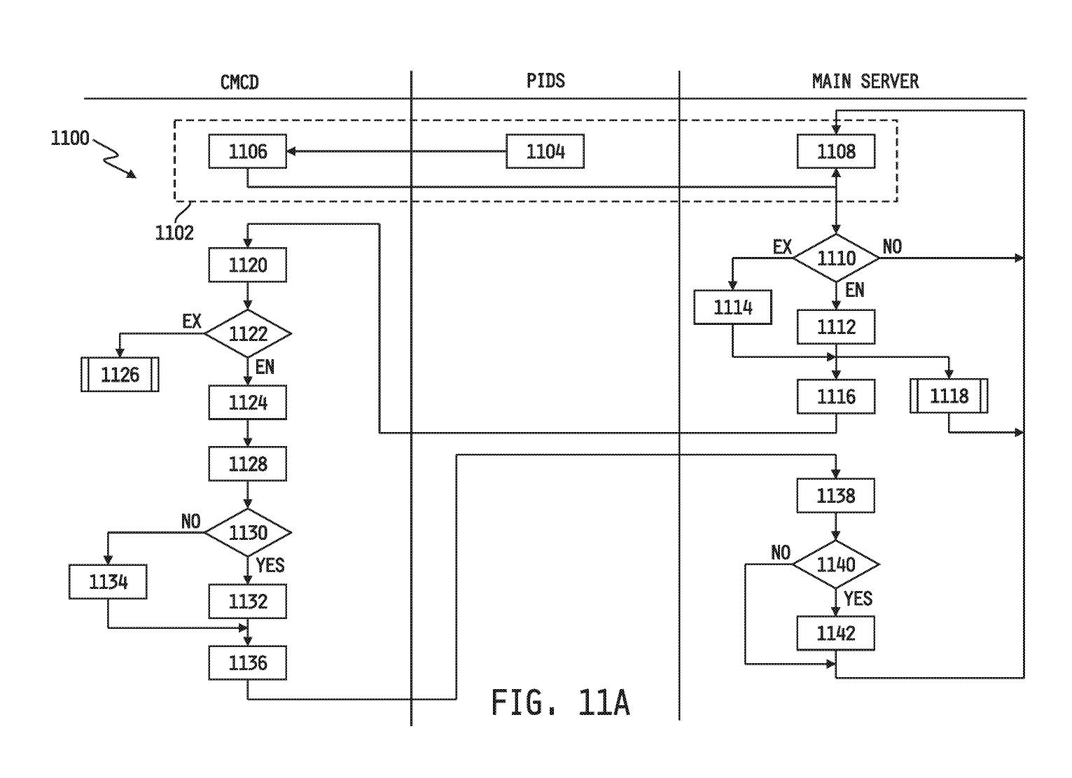

Referring now to FIG. 10, an embodiment 1000 of the crowd source help process executed at step 622 of the process 600 is shown. Illustratively, the process 1000 is stored in the MCA processing module 442 of the MCA module 440 in the form of instructions executable by the processor 50 of the main server 12. The process 1000 illustratively selects one or more in-store customers who have opted in as potential customer assistance providers, and in this regard the process 1000 illustratively begins at step 1002 where the processor 50 is operable to identify all in-store customers CSMCD₁-CSMCD_{M} that are available for customer assistance, where M may be any positive integer. Customers are available for customer assistance if, for example, such customers agree to do so and opt in using a process executed on their mobile devices as will be described by example below. Such customers may illustratively be identified at step 1002 using the same process described above for identifying the identity and location of the customer requesting assistance, e.g., such customer's mobile communication devices CSMCD₁-CSMCD_{M} detecting wireless signals broadcast by one or more of the in-store wireless signal broadcasting devices 26 identify themselves to the server 12, and the server 12 processes the wireless signals received therefrom to determine the identity (and location) of such customers.

In some embodiments, the process 1004 may include step 1004, and step 1004 is illustratively represented in FIG. 10 with dashed-line representation to indicate that step 1004 may be optional in some embodiments. In embodiment which include step 1004, the processor 50 is operable to execute a series of steps 1006-1022 which are substantially identical to corresponding steps 908-912, 916-918, 920 and 928-932 of the process 900 illustrated in FIG. 9. Similarly as described above with respect to such steps, the server 12 may have stored in the customer's preferences portion of the customer account data 404 or other storage location rating values for each crowd source customer that has helped the customer in the past and for whom the customer has stored a rating value. At steps 1006-1018, the processor 50 is operable to access such information for each identified in-store customer CMCD₁-CMCD_{M}, to determine a weighting value, W1ᵢ for each having a rating stored in the customer's account data 404, and to produce at step 1022 a sorted (and, in some embodiments, truncated) list of identified, in-store crowd source assistance customers available to provide customer assistance to the requesting customer. Following step 1022, the process 1000 returns to the process 600 illustrated in FIG. 6.

Referring again now to FIG. 6, in embodiments in which step 620 is executed, the processor 200 emerges with the identity or identities of one or more employees of the brick-and-mortar location 25 identified, e.g., in accordance with the process 900 illustrated in FIG. 9. The employee data 406 illustratively includes information relating to employee identification information for each employee of the retail enterprise, examples of which may include, but should not be limited to one or any combination of employee name, one or more digital photographs of the employee, brick-and-mortar location 25 at which the employee is located, work schedule of the employee, the position or function of the employee at the retail enterprise 11, communication information, CI, of an enterprise mobile communication device 18 assigned to or otherwise carried by the employee, and the like. Any such employee information is illustratively associated, e.g., linked or mapped, such that the processor 50 may be configured to search employee records within the employee data 406 according to any employee identifier. In this regard, the processor 50 illustratively has access to all such employee information for each employee identified at step 620, and the processor 50 may provide any such information to the requesting customer as described below. In any case, following step 620 the processor 50 is operable at step 624, in one embodiment, to wirelessly transmit to the enterprise mobile communication devices 18 of one or more such employees the help request received at step 612 or indicator thereof, the identity of the customer that made the request, and the estimated location of the customer within the identified brick-and-mortar location 25. Illustratively, the identity of the customer may include the customer's name and/or a digital photograph of the customer. In some alternative embodiments, the processor 50 may be operable to execute step 624 by transmitting the aforementioned information to a local hub server 22 which serves the identified brick-and-mortar location 25 and/or to one or more of the point-of-sale systems 24₁-24_{M} located therein, and the local hub server 22 and/or point-of-sale system may be configured to display the information and/or to wirelessly transmit the information to the one or more enterprise employees identified by the information.

In embodiments in which step 622 is executed, the processor 200 emerges with the identity or identities of one or more in-store customers of the brick-and-mortar location 25 identified, e.g., in accordance with the process 1000 illustrated in FIG. 100, which have volunteered to act as customer assistance providers. The customer account data 404 illustratively includes information relating to each such volunteer customer, and, as with the employee information, the processor 50 may provide any such information to the requesting customer. In any case, following step 620 the processor 50 is operable at step 624, in one embodiment, to wirelessly transmit to the enterprise mobile communication devices 18 of one or more such in-store customer the help request received at step 612 or indicator thereof, the identity of the customer that made the request, and the estimated location of the customer within the identified brick-and-mortar location 25.

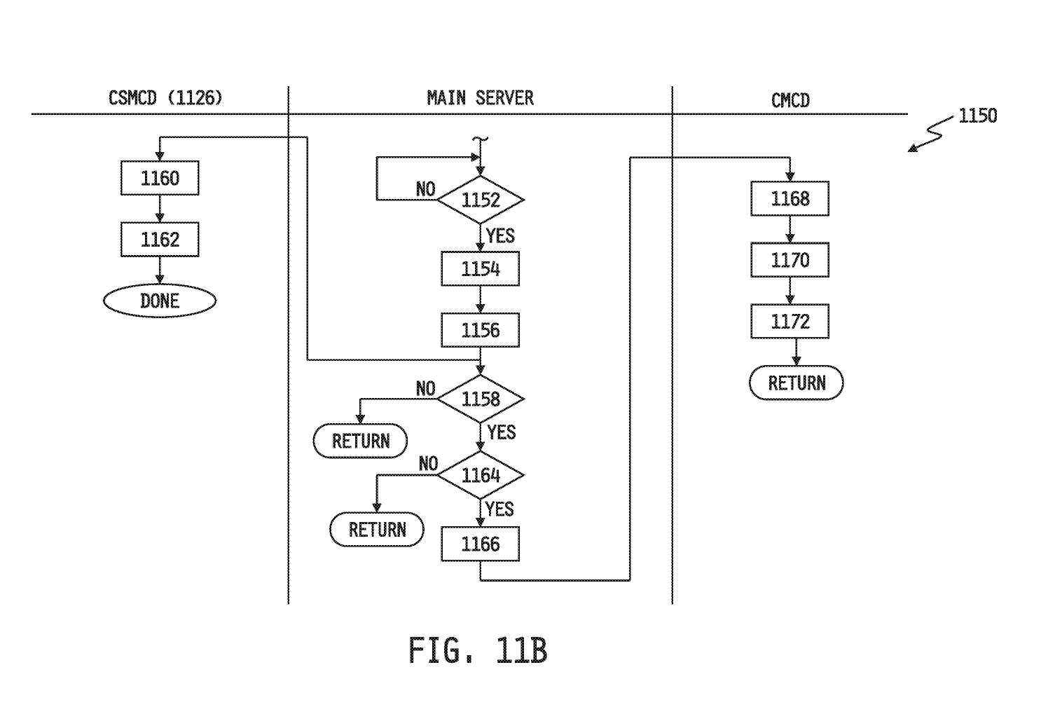

It will be understood that although the process steps 626-634, 642-644 and steps 656, 666, 672 and 694 are illustrated in FIG. 6 as being located below the heading “EMCD(S)” to indicate that such steps are executed by employee MOD's 18 when step 620 is executed, such process steps may alternatively be executed by an in-store customer's mobile communication device 16 in embodiments in which step 622 is executed such that the server 12 conducts communications with a mobile communication device 16 of a customer of the retail enterprise 11 who is presently in the same store 25 as the customer requesting assistance and who has volunteered to provide customer assistance via an opt-in process to be described in greater detail below with respect to FIG. 11A. Thus, while the following description of these steps is provided the context of communications conducted between the main server 12 and employee MCDs 18 and, in some embodiments, also between employee MCDs 18 and the CMCD 16 of the customer requesting assistance, it will be understood that such may also apply to the mobile communication devices 16 of volunteer, in-store customers of the retail enterprise 11 such that communications described with respect to the employee MCDs may take place instead with the mobile communication device 16 of a volunteer, in-store customer.

Referring now to FIG. 11A, an embodiment of an opt-in process 1100 is illustrated via which customers can volunteer to act as in-store, in-person customer assistance providers to other customers requesting assistance when in the same store as the requesting customer. The process 1100 is illustratively executed, in-part, by the processor 200 of a customer's mobile communication device 16, and in embodiments of the process 600 which include step 622 the process 1100 is illustratively stored in the memory 204 or data storage 206 of the customer mobile communication devices 16 and is selectively executable, e.g., via manual selection by the customer, to execute the process 1100. In some embodiments, the process 1100 may be included with, e.g., part of, the MCA application 214 stored in the memory 204. The process 1100 is also executed, in-part, by the processor 50 of the main server 12, and this portion of the process is illustratively stored in the memory 34 or data storage 36 and is executed by the processor 50 of the main server.

The process 1100 begins at step 1102 which illustratively include processes 1104, 1106 and 1108 carried out by the CMCD 16, one or more of the PIDs 26₁-26_{N} and the main server 12 respectively. The processes carried out at steps 1104, 1106 and 1108 are illustratively the same as carried out at step 608, 606 and 612-616 in that a mobile communication device 16 of an opting-in customer (“volunteer customer”) detects signals wirelessly broadcast by one or more PIDs 26₁-26_{N} located at one or more store entrances/exits and this initiates wireless communications between the customer's mobile communication device 16 and the main server 12 via which the processor 50 is operable to determine the location and identity of the volunteer customer's mobile communication device 16 (and thus the identity of the volunteer customer) as well as the location and identity of the one or more PIDs detected by the volunteer customer's mobile communication device 16. Thereafter at step 1110, the processor 50 is operable to determine whether the detected PID 26 is a store entrance/exit PID 26 or an in-store PID 26. If the latter, the process loops back to step 1108. If the former, the processor 50 is further operable at step 1110 to determine whether the customer is entering the store 25 or exiting the store 25. If the former, the process 11100 advances to steps 1114 and 1116 where the processor 50 is operable to control the communication circuitry 58 to wirelessly transmit to the detected customer's mobile communication device 16 an “enter” message, and if the latter the process 1100 advances to steps 112 and 1116 where the processor 50 is operable to control the communication circuitry 58 to wirelessly transmit to the detected customer's mobile communication device 16 an “enter” message. At step 1120, the detected customer's mobile communication device 16 receives the message if the message is an “enter” message the process 1100 advances from step 1122 to step 1124 where the processor 200 is operable to wake up and launch or active the MCA application 214 and to control the display 220 at step 1128 to display selectable customer assistance GUI elements. If, at step 1120 the detected mobile communication device 16 receives an “exit” message, the process 1100 advances to step 1126 where the processor 200 executes a store exit process. The process 1100 likewise advances to step 1118 if the processor 50 of the main server 12 transmits an “exit” message, and the processor 50 is operable at step 1118 to also execute a store exit process. An embodiment of the store exit process executed by the processor 200 of the detected customer's mobile communication device 16 at step 1126 and executed by the processor 50 of the server 12 at step 1118 is illustrated in FIG. 11B and will be described below.

If, at step 1130 the customer selects a “confirm” or “yes” customer assistant GUI element displayed at step 1128, the processor 200 transmits an “opt-in” message to the server 12 at steps 1132 and 1136, and if the customer selects a “decline” or “no” customer assistant GUI element displayed at step 1128, the processor 200 transmits an “opt-out” message to the server at steps 1134 and 1136. The server 12 receives the transmitted message at step 1138, and at steps 1140 and 1142 the processor 50 logs the customer into the crowd source assistant database 416 as an “active volunteer customer assistant”. If the message is an “opt-out” message, the process 1100 loops from step 1140 to step 1108 as it also does following step 1142.

Referring now to FIG. 11B, an embodiment 1150 is shown of the store exit process executed by the processor 200 of the detected customer's mobile communication device 16 at step 1126 of the process 1100 and also executed by the processor 50 of the server 12 at step 1118. The process 1150 is illustratively stored in the memory 204 or data storage 206 of the customer mobile communication devices 16 and is selectively executable, e.g., via manual selection by the customer, to execute the process 1150. In some embodiments, the process 1150 may be included with, e.g., part of, the MCA application 214 stored in the memory 204. The process 1150 is also executed, in-part, by the processor 50 of the main server 12, and this portion of the process is illustratively stored in the memory 34 or data storage 36 and is executed by the processor 50 of the main server. In some instances, a volunteer customer may exit the store after having been identified by the server 12 as a “customer service customer” available to assist in-store customers, and the process 1150 accounts for such possibilities in the illustrated embodiment by distinguishing between the mobile communication device 16 of the customer requesting assistance (“CMCD”) and the mobile communication device 16 of such a customer service customer (“CSMCD”).

The process 1150 begins at step 1152 where the processor 50 of the main server 12 is operable to determine whether the customer having just exited the store 25 is a customer service customer or another customer. The processor 50 is illustratively operable to execute step 1152 by accessing the crowd source assistance database 416 and determining whether or not the customer identified in step 1126 as exiting the store 25 is logged in as an active volunteer customer assistant. If so, the customer is a customer service customer and the process 1150 advances to step 1154, and otherwise the process 1150 loops back to the beginning of step 1152.

At step 1154 the processor 50 is operable to log the customer out of the crowd source assistant database 416 so that the customer becomes an “inactive volunteer customer assistant.” Thereafter at step 1156 the processor 50 controls the communication circuitry 58 to transmit a termination message to the CSMCD 16. At step 1160 the CSMCD 16 receives the termination message, and thereafter at step 1162 the processor 200 of the CSMCD is responsive to the message by terminating the MCA application which terminates the process 1150 for the CSMCD 16.

The process 1150 also advances from step 1156 to step 1158 where the processor 50 is operable to determine whether the customer having just exited the store 25 is currently identified as a customer service customer that is actively assisting a customer. If not, the process terminates, and otherwise the process 1150 advances to step 1164 where the processor 50 is operable to determine whether the requesting customer, i.e. the customer seeking in-person assistance, is still in the store. If not, the process 1150 terminates, and otherwise the processor transmits a restart message to the requesting customer's mobile communication device 16 at step 1166. The restart message is received by the requesting customer's mobile communication device at step 1168, and thereafter at step 1170 the processor 200 of the requesting customer's mobile communication device 16 is operable to control the display 220 to display a notification or message informing the requesting customer that another crowd source assistant must be obtained. Thereafter at step 1172, the processor 200 is operable to return to step 604 of the process 600 to re-request customer assistance and acquire another crowd source volunteer assistant or employee assistant. The process 1150 thereafter terminates and returns to step 1126 of the process 1100.

Referring again to the process 600 illustrated in FIG. 6, following step 624, the process 600 advances to step 626 where the information transmitted by the processor 50 of the main server 12 at step 624 is received by the enterprise mobile communication devices 18₁-18_{K} of the one or more employees identified at step 620. Thereafter at step 628, the received information illustratively causes the enterprise mobile communication devices 18 of the one or more employees identified at step 620 to wake up and automatically launch the MCA application 312 stored in the memories 304 thereof. The process 600 then advances to step 630 where the processors 300 in the enterprise mobile communication devices 18 of the one or more employees identified at step 620 each control the displays 316 on the devices 18 to display a graphic user interface (GUI) including an indicator of the help request and an acknowledgement element. Illustratively, the GUI may further include a display of the estimated location of the mobile communication device 16 of the customer that made the request, and may further still include information identifying the customer, such as the customer's name and/or photograph. In some embodiments, the processor 300 may be further operable at step 630 to display a layout or graphical map of at least a portion of the brick-and-mortar location 25, e.g., such as of the type illustrated in FIG. 7, with the estimate of the location of the customer's mobile communication device 16 superimposed thereon.

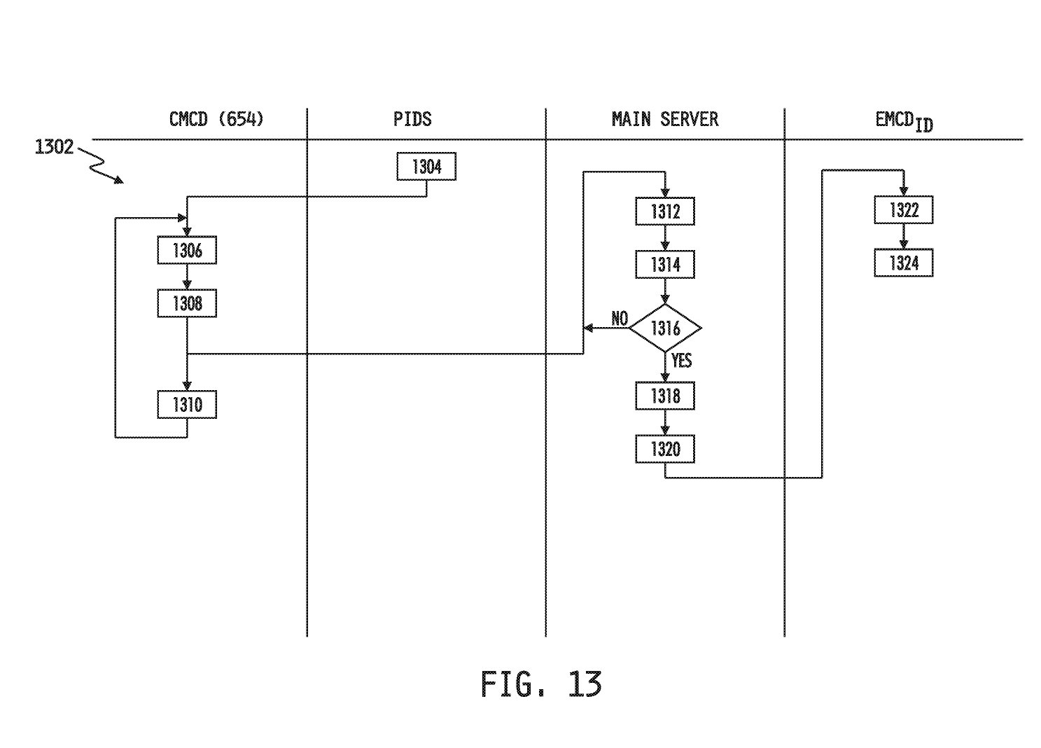

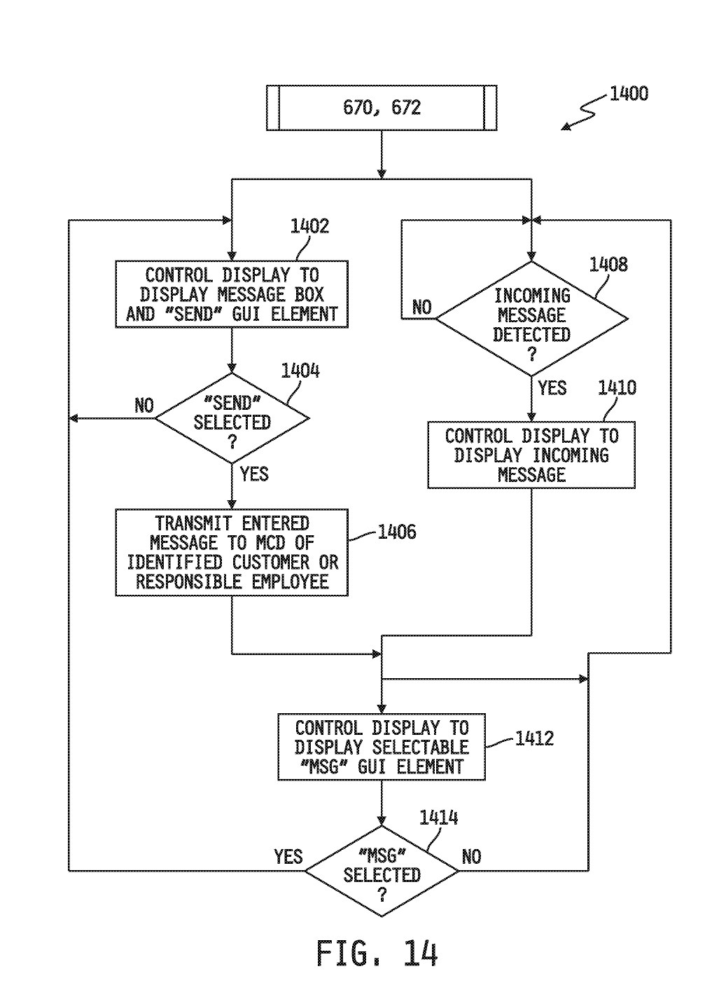

Following step 630, one of the employees identified at step 620 manually selects, at step 632, the acknowledgement element displayed on the display 316 of the employee's mobile communication device 18, thereby acknowledging and accepting responsibility by the employee (hereinafter “responsible employee) for providing in-person assistance to the customer that requested assistance at step 606. In one embodiment, the process 600 advances from step 632 to step 634 where the processor 300 of the responsible employee's mobile communication device 18 illustratively executes a portion of a customer location process which guides the responsible employee to the location of the customer within the brick-and-mortar location 25. One example embodiment of such a process executed at step 634 is illustrated in FIG. 13 and will be described in detail hereinafter. In some embodiments, the process 600 may also advance from step 632 to step 672 where the processor 300 of the responsible employee's mobile communication device launches or accesses a text communications application via which the responsible employee can conduct text communications with the customer requesting assistance. In such embodiments, the process 600 also includes a step 672 which may be executed following step 652, as will be described below, and at step 672 the processor 200 of the requesting customer's mobile communication device 16 likewise launches or accesses a text communications application via which the customer requesting assistance can conduct text communications with the responsible employee. An embodiment of a process for conducting such text communications at steps 670 and 672 is illustrated in FIG. 14 and will be described in detail below.

The processor 300 of the responsible employee's mobile communication device 18 is further illustratively responsive to the responsible employee's manual selection of the displayed acknowledgement element at step 632 to wirelessly transmit an acknowledgement signal, along with an identifier which identifies the responsible employee, to the main server 12. The main server 12 receives the wirelessly transmitted acknowledgement signal at step 636, and thereafter at step 638 the processor 50 of the main server 12 is operable to process the wirelessly received acknowledgment and identifier to determine the identity of the responsible employee. Illustratively, the processor 50 is operable to execute step 638 by comparing the wirelessly received identifier to the employee information stored in the employee data 406 and identifying a matching one of the employees in the employee data 406 as the responsible employee. Thereafter at step 640, the processor 50 is operable to transmit the acknowledgment signal, or another acknowledgment signal, to the mobile computing devices 18 of the one or more employees identified at step 620, and at step 642 the mobile communication devices of such employees receive the acknowledgement signal transmitted by the processor 50. Thereafter at step 644, the processors 300 of the mobile communication devices 18 receiving the acknowledgment signal are operable to control the displays 316 thereof to display a message indicating that one of the employees (the “responsible employee”) has accepted responsibility for providing in-person assistance to the requesting customer. In some embodiments, the processor 50 may transmit at step 640, and the processors 300 may control the displays 316 at step 644 to display, the identity of the responsible employee.

The process 600 illustratively advances from step 640 to step 646 where the processor 50 is operable to wirelessly transmit a response signal to the customer's mobile communication device 16. The wirelessly transmitted response signal is received at step 650, and thereafter at step 652 the processor 200 of the customer's mobile communication device 16 is operable to control the display 216 to display a message indicating that the help request was received and/or that an employee of the brick-and-mortar location 25 has been dispatched to provide the customer with in-person assistance. In some embodiments, the processor 50 may transmit at step 646, and the processors 200 may control the display 218 at step 652 to display, the identity of the responsible employee.

In one embodiment, the process 600 advances from step 646 to step 648 where the processor 50 of the main server 12 illustratively executes a portion of the customer location process which guides the responsible employee to the location of the customer within the brick-and-mortar location 25. In such embodiments, the process 600 also advances from step 652 to step 654 where the processor 200 of the customer's mobile communication device 16 also illustratively executes a portion of the customer location process in which guides the responsible employee to the location of the customer within the brick-and-mortar location 25. One example embodiment of such a process executed at steps 648 and 654 is illustrated in FIG. 8 and will be described in detail below. As briefly described above, the process 600 may, in some embodiments, also include a step 670 to which the process 600 advances from step 652, and at steps 670 and 672 the processors 200 and 300 of the requesting customer's mobile communication device 16 and the responsible employee's mobile communication device 18 execute a text communications process to exchange text communications between the requesting customer and the responsible employee. An example embodiment of such a text communications process is illustrated in FIG. 14 and will be described in detail below.

It is envisioned that, in some instances, the requesting customer may wander or otherwise move from the customer's originally estimated location between the time that the processor 50 estimates the location of the customer within the brick-and-mortar location 25 at step 614 and the time taken by the responsible employee to travel to the estimated location. An additional customer location process may therefore be implemented in some embodiments, which process illustratively continues to track the location of the customer's mobile communication device 16 after the responsible employee has been dispatched to provide in-person assistance to the requesting customer. One embodiment of such a process 1302 is illustrated in FIG. 13, and represents an example embodiment of the processes executed at steps 634, 648 and 654 of the process 600 illustrated in FIG. 6.

Referring now to FIG. 13, the execution framework of the illustrated process 1302 is identical to that of the process 600. And like the process 600 described above, the process 1302 is illustratively stored in the same memories and/or data storage and executed by the same processors described with respect to the process 600. In the process 1302 illustrated in FIG. 13, item 1304 identifies action taken by the plurality of wireless signal broadcasting devices 26₁-26_{N} wherein each of the plurality of wireless signal broadcasting devices 26₁-26_{N} operate to broadcast wireless identification signals as described in detail hereinabove. The process 1302 begins at step 1306 where the processor 200 of the requesting customer's mobile communication device 16 is operable to detect any such broadcast wireless signals within the broadcast range of the customer's mobile communication device 16. Thereafter at step 1308, the processor 200 is operable to wirelessly transmit one or more wireless signals to the main server 12, e.g., to control the communication circuitry 216 in the device 16 to wirelessly transmit one or more signals to the main server 12 via the public network 14 as illustrated in FIG. 5. The one or more wireless signals at step 1308 illustratively contain(s) the unique identification (UID) of each in-range wireless signal broadcasting device 26₁-26_{N} as described above with respect to step 610 of the process 600. Thereafter at step 1310, the processor 200 is operable to wait for a delay period, and after expiration of the delay period the processor 200 again executes step 1304. As such, the processor 200 is operable to periodically provide updated UID information to the main server 12 at a rate determined by the delay period. In some embodiments, the delay period may be several seconds, although in other embodiments the delay period may be shorter or longer.

At step 1312, the processor 50 of the main server 12 is operable to receive the wireless signals transmitted by the customer's mobile communication device 16 at step 1308, and thereafter at step 1314 the processor 50 is operable to process the received UIDs, e.g., as described above with respect to step 614 of the process 600, to determine an updated estimate of the location of the customer's mobile communication device 16 based on the updated UIDs. Thereafter at step 1316, the processor 50 is operable to compare the updated estimate of the location of the customer's mobile communication device 16 with the most recent previous estimate of the location of the customer's mobile communication device 16. If, based on this comparison, the processor 50 determines that the updated estimate of the location of the customer's mobile communication device 16 has not changed from the most recent previous estimate by more than a predetermined distance, the processor 50 returns to step 1312 to await new updated UID information to be wirelessly transmitted by the customer's mobile communication device 16. If, at step 1316, the processor 50 determines that the updated estimate of the location of the customer's mobile communication device 16 has changed from the most recent previous estimate by more than the predetermined distance, the process 1302 advances to step 1318 where the processor 50 is operable to store the updated estimate of the location of the customer's mobile communication device 16 in the memory 54, and thereafter at step 1320 the processor 50 is operable to wirelessly transmit the updated estimate of the location of the customer's mobile communication device 16 to the responsible employee's mobile communication device 18.

At step 1322, the processor 300 of the responsible employee's mobile communication device 18 receives the updated estimate of the location of the customer's mobile communication device 16 wirelessly transmitted by the main server 12. Thereafter at step 1324, the processor 300 of the responsible employee's mobile communication device 18 is operable to control the display 316 to display the updated estimate of the location of the customer's mobile communication device 16. In some embodiments, as described above with respect to step 630, the processor 300 may be operable at step 1324 to display a layout or graphical map of at least a portion of the brick-and-mortar location 25, e.g., such as of the type illustrated in FIG. 7, with the estimate of the location of the customer's mobile communication device 16 superimposed thereon.

In the embodiment of the process 600 illustrated in FIG. 6, the process 1302 just described is illustratively executed in tandem such that the process 600 remains active until the responsible employee manually provides input after locating the requesting customer. In such embodiments, the processor 300 of the responsible employee's mobile communication device 18 is further illustratively operable at step 1324 to display a selectable graphic user interface element which the responsible employee may manually select, e.g., via a keypad or touch-screen, when the responsible employee has located the requesting customer within the brick-and-mortar location 25. As illustrated in FIG. 6, the process 600 advances, in response to such user selection of the selectable graphic user interface element displayed on the display 316 of the responsible employee's mobile communication device, from step 634 to step 656 where the processor 300 is operable wirelessly transmit a customer located signal to the main server 12. The process 600 also advances from step 656 to step 666 where the processor 300 is operable to exit the guide application. At step 658 the processor 50 of the main server 12 receives the customer located signal transmitted at step 656, and at step 660 the processor 50 is illustratively operable to wirelessly transmit a stop signal to the customer's mobile communication device 16. The processor 200 of the customer's wireless communication circuit 16 receives the wirelessly transmitted stop signal at step 662, and at step 664 the processor 200 is operable to exit the process 600.

In some embodiments, as described above with respect to the processes 900 and 1000 illustrated in FIGS. 9 and 10 respectively, the requesting customer may rate the employee or the volunteer customer which provided the requesting customer with assistance. In such embodiments, the process 600 illustratively includes a step 674 which is illustrated by dashed line representation to indicate that step 674 is optional in some embodiments. In embodiments which include step 674, the processor 200 of the requesting customer's mobile communication device 16 is operable to control the display 220 to display one or more selectable GUI elements along with instructions to select one of the GUI elements to rate the individual, e.g., store employee or customer volunteer, who just provided the requesting customer with customer assistance. If the customer elects to rate the individual who just provided assistance via appropriate selection of one of the displayed GUI elements, the process 600 advances to step 678 where the processor 200 is illustratively operable to display multiple selectable GUI elements each corresponding to a different rating value or range of rating values. Upon selection of one of the displayed GUI elements at step 680, the process 600 advances to step 682 where the processor 200 is operable to control the communication circuitry 212 to wirelessly transmit the selected rating to the main server 12. At step 684 the server 12 receives the transmitted rating, and thereafter at step 686 the processor 50 is operable to store the received rating value in the MCA preferences portion of the customer account data 404 associated with the requesting customer. Thereafter, the process 600 terminates.

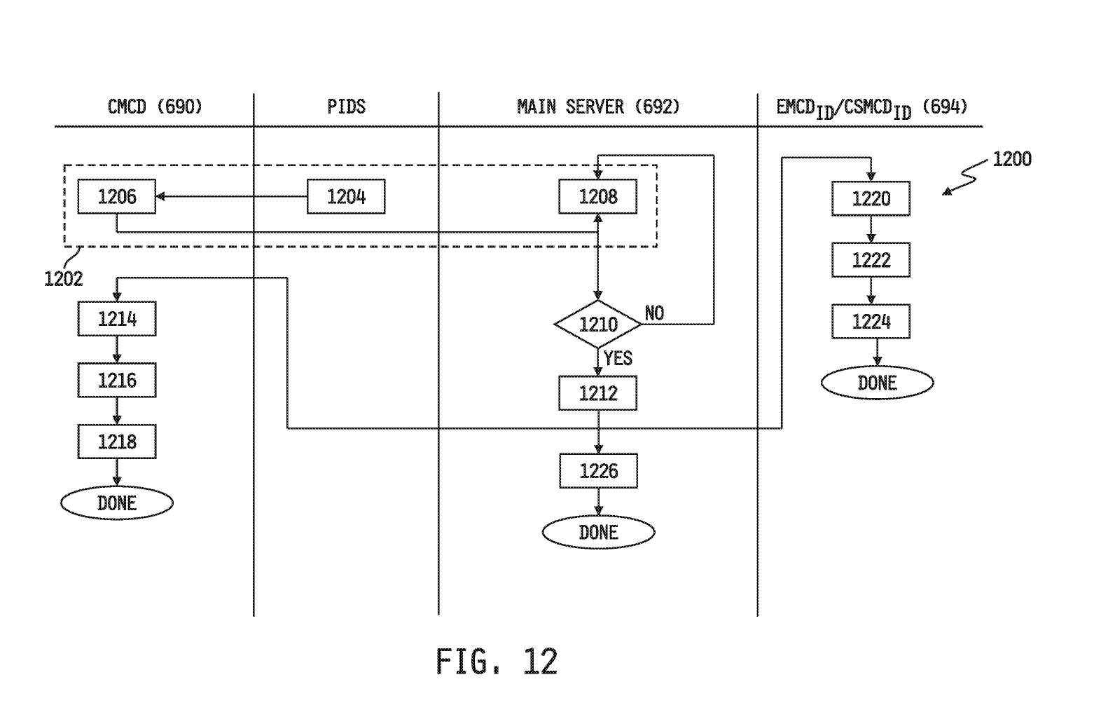

It is envisioned that some requesting customers may exit the store 25 after requesting assistance but prior to location of the requesting customer by the responsible employee or identified customer service customer, i.e., the volunteer, opted-in customer identified to provide the requesting customer with in-person assistance. It may be desirable in such instances to terminate the MCA application being executed by the requesting customer's mobile communication device 16 and to also notify the responsible employee or identified customer assistance customer that the requesting customer has exited the store 25. In some embodiments, the process 600 accommodates this scenario by inclusion of steps 690, 692 and 694 following steps 604, 620 and 630 respectively. An embodiment of a requesting customer exit process for executing steps 690, 692 and 694 is illustrated in FIG. 12 and will be described in detail below.

Referring now to FIG. 12, an embodiment 1200 is shown of the requesting customer exit process executed at steps 690, 692 and 694 of the process 600 illustrated in FIG. 6. The execution framework of the illustrated process 1200 is similar to that of the process 600 except that the process 1200 includes another portion to the right of that executed by the main server 12, which is shown under the heading “EMCD_{ID}/CSMCD_{ID}.” In embodiments in which a store employee is identified as the responsible employee providing in-person customer assistance, this portion of the process 1200 is illustratively stored in a memory 304 of the responsible employee's identified mobile communication device 18 (EMCD_{ID}) and executed by a processor 300 of the responsible employee's identified mobile communication device 18 (EMCD_{ID}), and in embodiments in which an opted-in store customer is identified as the responsible customer service customer providing in-person customer assistance, this portion of the process 1200 is illustratively stored in the memory 204 of the responsible customer service customer's identified mobile communication device 16 (CSMCD_{ID}) and executed by a processor 200 of the responsible customer service customer's identified mobile communication device 16 (CSMCD_{ID}). Like the process 600 described above, the remainder of the process 1200 is illustratively stored in the same memories and/or data storage and executed by the same processors described with respect to the process 600.

The process 1200 begins at step 1202 which illustratively includes processes 1204, 1206 and 1208 carried out by the CMCD 16, one or more of the PIDs 26₁-26_{N} and the main server 12 respectively. The processes carried out at steps 1204, 1206 and 1208 are illustratively the same as carried out at step 608, 606 and 612-616 of the process 600 in that a mobile communication device 16 of the requesting customer detects signals wirelessly broadcast by one or more PIDs 26₁-26_{N} located at one or more store entrances/exits and this initiates wireless communications between the customer's mobile communication device 16 and the main server 12 via which the processor 50 is operable to determine the location of the requesting customer. Thereafter at step 1210, the processor 50 is operable to determine whether the customer has exited the store 25 and, if not, the process 1200 loops back to the beginning of step 1200. If the processor 50 determines at step 1210 that the requesting customer has exited the store 25, the processor 50 is operable at step 1212 to transmit a termination message to the requesting customer's mobile communication device 16 and to transmit a quit message to the EMCD_{ID} 18 or CSMID_{ID} 16. Thereafter at step 1226 the process 1200 terminates for the processor 50 with respect to the requesting customer's request for customer assistance.

At step 1214, the mobile communication device 16 of the requesting customer receives the termination message, and thereafter at step 1216 the processor 200 of the requesting customer's mobile communication device 16 is operable to control the display 220 informing of the automatic termination of the MCA application 214 being executed by the processor 200. Thereafter at step 1218 the process 600 being executed by the processor 200 of the requesting customer's mobile communication device 16 is terminated, and thereafter the process 1200 terminates for the requesting customer′ mobile communication device 16.

At step 1220, the mobile communication device EMCD_{ID} 18 or CSMCD_{ID} 16 receives the quit message, and thereafter at step 1222 the processor 300 of the EMCD_{ID} 18 or the processor 200 of the CSMCD_{ID} 16 is operable to control the display of the device 18, 16 respectively to display a message informing of the requesting customer's exit from the store 25. Thereafter at step 1224 the processor 300 of the EMCD_{ID} 18 or the processor 200 of the CSMCD_{ID} 16 is operable to terminate the process 600, and thereafter the process 1200 terminates for the EMCD_{ID} 18 or CSMCD_{ID} 16.

Referring now to FIG. 14, an embodiment 1400 is shown of the text communications process executed at steps 670 and 672 of the process 600 illustrated in FIG. 6. The process 1400 is illustratively stored in the memory 204 of customer mobile communication devices 16₁-16_{J} and is executed by the processor 200. In some embodiments, the process 1400 is included with, e.g. is part of, the MCA application 214 stored in the memory 204. The process 1400 is also illustratively stored in the memory 204 of employee mobile communication devices 18₁-18_{K} and is executed by the processor 300. In some embodiments, the process 1400 is included with, e.g. is part of, the MCA application 314. In any case, the process 1400 begins at step 1402 where the processor executing the process 1400 is operable to control the display of the device to display a text message box or field with a “send” GUI element. Thereafter at steps 1404 and 1406 the processor executing the process 1400 is responsive to detection of the “send” GUI element to transmit the text in the text box or field to the mobile communication device of the other party. Thereafter at step 1408, the processor executing the process 1400 is operable to determine whether an incoming text message has been detected, and if so the processor controls the device display at step 1410 to display the incoming message. The process 1400 advances from step 1410, and also from step 1406, to step 1412 where the processor executing the process 1400 is operable to control the device display to display a selectable “Message” GUI element, and at step 1414 if the “Message” GUI element has been selected the process 1400 loops to the beginning of step 1402 and to the beginning of step 1408.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. Moreover, it will be understood that while several process steps in various sequences have been illustrated and described herein with respect to the processes 600, 800, 900, 1000, 1100, 1150, 1200, 1302 and 1400 either or both of the processes 600, 800, 900, 1000, 1100, 1150, 1200, 1302 and 1400 may alternatively include more, fewer and/or different steps, and that any such steps may be executed in different sequences from those illustrated and described, without departing from the scope of the concepts and techniques described herein.

In the embodiments described herein, the position identification devise 26₁-26_{N} have been described as being implemented as wireless signal broadcasting devices, e.g., conventional radio frequency broadcasting beacons, configured to broadcast wireless signals each containing UID. In some alternate embodiments, one or more of the PIDs may be implemented as wireless signal transceivers configured to can broadcast and receive wireless signals and/or as wireless signal receivers configured to receive broadcast wireless signals, e.g., broadcast by a mobile communication device or other device and, in some cases, to communicate directly (wired and/or wirelessly) with the main server 12, one or more of the local hub servers 22 and/or one or more of the POS systems 24. In some such embodiments, one or more of the wireless signal transceivers and/or receivers may include one or more conventional processors and one or more memory devices having instructions stored therein executable by the one or more processors to execute one or more of steps for determining an identity of an individual carrying a mobile communication device within and/or near a store 25.

In other alternate embodiments, one or more PIDs 26 may be implemented in the form of a combination of conventional Global Positioning System (GPS) satellites and a GPS receiver on-board a mobile communication device.

In other alternate embodiments, one or more PIDs 26 may be implemented in the form of one or more in-store WiFi Access Points which establish one or more in-store or store-wide hotspot having a unique internet access ID (HotSpotID) accessible by a mobile communication device. In such embodiments, the server 12 may determine a location of a mobile communication device in accordance with the unique internet access ID used by the mobile communication device to communicate with the mobile communication device.

In other alternate embodiments, one or more PIDs 26 may be implemented in the form of a combination of the earth's Geomagnetic Field and a magnetometer on-board a mobile communication device. In such embodiments, the server 12 may determine the location of a mobile communication device in accordance with the unique magnetic field signature captured by the magnetometer and wirelessly transmitted to the server 12 by the mobile communication device. In such embodiments, the server database may have one or more maps, tables, lists or the like mapping magnetic signature profiles within one or more of the stores to locations or positions within one or more of the stores, and the server 12 may be operable in such embodiments to determine the in-store location or position of a mobile communication device by comparing the unique magnetic field signature wirelessly transmitted by the mobile communication device to the stored magnetic signature profiles.

In other alternate embodiments, one or more of the PIDs may be implemented in the form of a combination of a camera on-board a mobile communication device and a product label affixed to product or product location within a store. In such embodiments, the camera may be operated to capture an image of the product label and wirelessly transmit the image to the server. The server may then compare the image to stored product data to determine the in-store location thereof.

In other alternate embodiments, one or more of the PIDs may be implemented in the form of a combination of a mobile communication device with a keypad and a customer/employee application operating on the mobile communication device. In such embodiments, the customer/employee application may display one or more manually selectable GUI elements for manually entering the location of the mobile communication device, and the mobile communication device may then wirelessly transmit the location information to the server.

In other alternate embodiments, one or more of the PIDs may be implemented in the form of a wireless signal transmission device, e.g., RFID Tag, NFC device, etc., attached to customer-selected product. In such embodiments, the wireless signal transmission device may be configured to wirelessly transmit product information (e.g., brand, size, etc.) and/or location (e.g., department, aisle, shelf position, etc.) to a mobile communication device which then wirelessly transmits the information to the server.

In other alternate embodiments, one or more of the PIDs may be implemented in the form of a combination of one or more in-store Cameras and a server-based facial and/or product recognition application. In some such embodiments, the server may process camera images and/or video and compare facial images with stored customer images to identify customers. In other embodiments, the server may process the camera images and/or video and compare product images, e.g., in customer's possession (basket, hand-carried, etc.) with stored product images, and then predict the customer's identity based on information contained in customer shopping histories.

In other alternate embodiments, one or more PIDs may be implemented in the form of a combination of one or more electromagnetic radiation (EMR) generators positioned within a store 25 and a mobile communication device with a camera and/or microphone. In such embodiments, the EMR may be generated in one or more spectral ranges, and be made to vary locally from store-to-store and throughout each store in one or more detectable EMR properties or characteristics, and/or EMR having different properties or characteristics may be generated in each store and in different areas of each store, such that in any case different stores, and different areas within each store, will be subject to different generated EMR properties or characteristics. The different EMR properties and/or characteristics generated in each store and in each area of each store may be stored in an EMR database, and local EMR properties/characteristics may be detected by a mobile communication device and wirelessly transmitted to the server which may then compare such received information to the EMR database to determine the location of the mobile communication device. Examples of such EMR generators and corresponding EMR detectors include, but are not limited to, one or more visible Light Generators and a camera on-board a mobile communication device, one or more audible frequency Generators and a microphone on-board a mobile communication device, one or more radio frequency generators and a radio frequency generator on board a mobile communication device, and the like.

In other alternate embodiments, one or more PIDs may be implemented in the form of one or more mobile communication devices of one or more in-store customers or in-store Employees. In such embodiments, in-store mobile communication devices may be configured to periodically broadcast signals detected by a customer's mobile communication device and/or transmitted directly to the server. Such broadcast signals be or include “location information” signals based on one or more “hard events” such as a recently received unique identification signal transmitted by an in-store wireless signal broadcasting device, a recently scanned or imaged product code, detected product device data, recently received GPS data, recently used HotSpotID data, recently detected EMR data, and/or the like. Alternatively or additionally, the one or more broadcast signals may be or include location information signals based on one or more “soft events” such as locally detected sounds (generated or not), locally detected light (generated or not), locally detected RF signals, and/or the like.

In any of the foregoing embodiments, information may be transmitted, receive and/or processed by any one or combination of any system or device disclosed herein.

What is claimed is:

1. A method of providing in-person retailer assistance to customers of a retail enterprise, the method comprising:
associating, with a processor in a first database, each of a plurality of locations within a brick-and-mortar outlet of the retail enterprise with a different identification code,
associating, with the processor in the first or a second database, each of a plurality of customer codes with a different one of a plurality of customers of the retail enterprise, and associating each of a plurality of employee codes identifying a different one of a plurality of employees of the brick-and-mortar outlet with a mobile communication device associated with the different one of the plurality of employees, and
in response to a wirelessly received help request, customer code and one or more identification codes, identifying with the processor the one of the plurality of customer codes in the first or second database that matches the wirelessly received customer code, identifying with the processor each of the plurality of locations associated in the first database with an identification code that matches one of the one or more wirelessly received identification codes, determining with the processor a customer location within the brick-and-mortar outlet based on the identified one or more locations, and wirelessly transmitting to one or more of the plurality of employee mobile communication devices, under control of the processor, the help request and an identity of the customer associated in the first or second database with the matching one of the plurality of customer codes and the customer location within the brick-and-mortar outlet.

2. The method of claim 1 further comprising, in response to an acknowledgement and employee code wirelessly received from one of the one or more of the plurality of employee communication devices, identifying with the processor the one of the plurality of employee codes in the first or second database that matches the wirelessly received employee code, and wirelessly transmitting to a customer mobile communication device identified by the matching one of the plurality of customer codes, under control of the processor, a notification message including information relating to at least one of an affirmative response to the help request and an identity of the employee associated in the at least one database with the matching one of the plurality of employee codes.

3. The method of claim 1 wherein each of the plurality of customer codes comprises contact information identifying a different customer mobile communication device associated with a corresponding different one of a plurality of customers of the retail enterprise.

4. The method of either claim 1 further comprising associating, with the first processor in the first or second database, each of the plurality of customer codes with contact information identifying a customer mobile communication device associated with a different one of the plurality of customers, and
identifying, in response to one of the wirelessly received help request, customer code and one or more identification codes and the acknowledgement and employee code wirelessly received from one of the one or more of the plurality of employee communication devices, the customer mobile communication device identified by the contact information associated in the first or second database with the matching one of the plurality of customer codes.

5. The method of claim 1, further comprising:
periodically wirelessly receiving from the identified customer mobile communication device one or more updated identification codes,
identifying updated ones of each of the plurality of locations associated in the first database with an identification code that matches one of the one or more wirelessly received updated identification codes,
determining an updated customer location within the brick-and-mortar outlet based on the identified one or more updated locations, and
wirelessly transmitting to the one of the one or more of the plurality of employee mobile communication devices the updated customer location within the brick-and-mortar outlet.

6. A system for providing in-person retailer assistance to customers of a retail enterprise, the system comprising:
a plurality of wireless signal broadcasting devices located in a brick-and-mortar outlet of the retail enterprise,
at least one database having stored therein a plurality of device codes each identifying a different one of the plurality of wireless signal broadcasting devices and each associated in the at least one database with a location within the brick-and-mortar outlet of the different one of the plurality of wireless signal broadcasting devices, a plurality of customer codes each identifying a different one of a plurality of customers of the retail enterprise, and a plurality of employee codes each identifying a different one of a plurality of employees of the brick-and-mortar outlet of the retail enterprise and each associated in the at least one database with a different employee mobile communication device,
a processor, and
memory having instructions stored therein which, when executed by the processor, cause the processor, in response to a wirelessly received help request, customer code and one or more device codes, to identify the one of the plurality of customer codes in the at least one database that matches the wirelessly received customer code, to identify each of the plurality of device codes in the at least one database that match one of the one or more wirelessly received device codes, to identify each device location associated in the at least one database with the matching one or more device codes, to determine a customer location within the brick-and-mortar outlet based on the one or more identified device locations, and to wirelessly transmit to one or more of the plurality of employee mobile communication devices the help request, an identity of the customer associated in the at least one database with the matching one of the plurality of customer codes and the customer location within the brick-and-mortar outlet.

7. The system of claim 6 wherein the instructions stored in the memory further include instructions which, when executed by the processor, cause the processor, in response to an acknowledgement and employee code wirelessly received from one of the one or more of the plurality of employee communication devices, to identify the one of the plurality of employee codes in the at least one database that matches the wirelessly received employee code, and to wirelessly transmit to a customer mobile communication device identified by the matching one of the plurality of customer codes a notification message including information relating to at least one of an affirmative response to the help request and an identity of the employee associated in the at least one database with the matching one of the plurality of employee codes.

8. The system claim 6 wherein the plurality of customer codes stored in the at least one database each comprise contact information identifying a different customer mobile communication device associated with a corresponding different one of a plurality of customers of the retail enterprise.

9. The system of claim 6 wherein the plurality of customer codes stored in the at least one database are each associated in the at least one database with contact information identifying a different customer mobile communication device associated with a corresponding different one of a plurality of customers of the retail enterprise, and wherein the instructions stored in the memory further include instructions which, when executed by the processor, cause the processor to identify, in response to one of the wirelessly received help request, customer code and one or more identification codes and the acknowledgement and employee code wirelessly received from the one of the one or more of the plurality of employee communication devices, the customer mobile communication device identified by the contact information associated in the at least one database with the matching one of the plurality of customer codes.

10. The system of claim 7, wherein the instructions stored in the memory further include instructions which, when executed by the processor, cause the processor to:
periodically wirelessly receive from the identified customer mobile communication device one or more updated identification codes,
identify updated ones of each of the plurality of device codes in the at least one database that match one of the one or more wirelessly received updated device codes, identify each updated device location associated in the at least one database with the matching one or more updated device codes,
determine an updated customer location within the brick-and-mortar outlet based on the one or more identified updated device locations, and
wirelessly transmit to the one of the one or more of the plurality of employee mobile communication devices the updated customer location within the brick-and-mortar outlet.

11. A system for providing in-person retailer assistance to customers of a retail enterprise, the system comprising:
a plurality of wireless signal broadcasting devices located in a brick-and-mortar outlet of the retail enterprise,
at least one database having stored therein a plurality of device codes each identifying a different one of the plurality of wireless signal broadcasting devices and each associated in the at least one database with a location within the brick-and-mortar outlet of the different one of the plurality of wireless signal broadcasting devices, a plurality of customer codes each identifying a different one of a plurality of customers of the retail enterprise, and a plurality of employee codes each identifying a different one of a plurality of employees of the brick-and-mortar outlet of the retail enterprise and each associated in the at least one database with a different employee mobile communication device, and
a server coupled to each of the plurality of wireless signal broadcasting devices and including at least one module to, in response to a wirelessly received help request, customer code and one or more device codes, identify the one of the plurality of customer codes in the at least one database that matches the wirelessly received customer code, identify each of the plurality of device codes in the at least one database that match one of the one or more wirelessly received device codes, identify each device location associated in the at least one database with the matching one or more device codes, determine a customer location within the brick-and-mortar outlet based on the one or more identified device locations, and wirelessly transmit to one or more of the plurality of employee mobile communication devices the help request, an identity of the customer associated in the at least one database with the matching one of the plurality of customer codes and the customer location within the brick-and-mortar outlet.

12. The system of claim 11 wherein the at least one server module to, in response to an acknowledgement and employee code wirelessly received from one of the one or more of the plurality of employee communication devices, identify the one of the plurality of employee codes in the at least one database that matches the wirelessly received employee code, and wirelessly transmit to a customer mobile communication device identified by the matching one of the plurality of customer codes a notification message including information relating to at least one of an affirmative response to the help request and an identity of the employee associated in the at least one database with the matching one of the plurality of employee codes.
